(19) United States
(12) Patent Application Publication
(10) Pub. No.: US 2017/0051185 A1
(43) Pub. Date: Feb. 23, 2017

(54) MULTI-LAYER COVER TAPE CONSTRUCTIONS WITH GRAPHITE COATINGS

(71) Applicant: 3M INNOVATIVE PROPERTIES COMPANY, St. Paul, MN (US)

(72) Inventors: Shiow Shya Ling, Singapore (SG); Ranjith Divigalpitiya, Ontario (CA); Kam Poi Chia, Singapore (SG); Carol A. Marek, Cedar Park, TX (US); Gerrard A. Marra, Ontario (CA)

(21) Appl. No.: 15/119,626

(22) PCT Filed: Feb. 12, 2015
(86) PCT No.: PCT/US2015/015527

§ 371 Date: Aug. 17, 2016

Related U.S. Application Data
(60) Provisional application No. 61/942,236, filed on Feb. 20, 2014.

(51) Int. Cl. C09J 7/02; B32B 7/12; B32B 27/08; B32B 27/40; B32B 27/30; B32B 27/32; B32B 27/36; C09J 133/08; B32B 27/20

(52) U.S. Cl. CPC C09J 7/0246; C09J 7/0257; C09J 7/0275; C09J 133/08; B32B 7/12; B32B 27/08; B32B 27/20; B32B 27/308; B32B 27/32; B32B 27/36; B32B 27/365; B32B 27/40; C09J 2203/326; C09J 2201/28; C09J 2433/003; C09J 2423/106; B32B 2255/26; B32B 2264/108; B32B 2307/202; B32B 2307/412; B32B 2307/536; B32B 2307/554; B32B 2307/584; B32B 2405/00

(57) ABSTRACT

Multi-layer cover tape constructions include a polymeric substrate with a low adhesion backsize coating layer on one surface and an adhesive layer on the other surface, with a conductive film construction adhered to a portion of the adhesive layer such that portions of the adhesive remain exposed. The conductive film construction includes a polymeric substrate with an exposed layer of abrasion-resistant, electrically conductive nano-scale graphite coated by buff coating. Other multi-layer cover tape constructions include a polymeric substrate with a low adhesion backsize coating layer on one surface, and an exposed layer of abrasion-resistant, electrically conductive nano-scale graphite particles coated on the other surface. Stripes of adhesive are present on a portion of the electrically conductive coating such that portions of the electrically conductive coating remain exposed between the adhesive stripes. Carrier tapes include a plurality of indented segments for accommodating electronic components and are releasably sealed by a cover tape.

### FIELD OF THE DISCLOSURE

This disclosure relates to multi-layer cover tape constructions and the use of these cover tapes in carrier tape assemblies.

### BACKGROUND

As electronic parts have become more miniature, storage, transportation and handling of such components has become more difficult, and specialized methods have evolved. One such method is use of a carrier tape. A carrier tape can be formed of a variety of materials, but are typically a plastic material formed in a strip which has multiple longitudinal recesses or indentions meant to hold individual components to prevent them from touching each other or being otherwise exposed to trauma. Such indented segments must have an upper opening by which the component is placed into the recess, and then the opening must be sealed, generally by means of a cover tape.

One material suggested for the cover tape used in punched carrier tapes is a multi-layer laminated polymeric foam structure, as in U.S. Pat. No. 4,657,137. This tape requires the use of at least two separate layers and is produced by providing a flexible thin plastic or foam layer to which a strong and stable base layer is laminated.

The carrier tape disclosed in U.S. Pat. No. 4,964,405 has a cover tape pasted with an adhesive which seals only the recesses and leaves the guide perforations open.

The cover tapes normally used for carrier tapes have e.g., nylon based substrates coated at least partially with an adhesive such as ethylene/vinyl acetate. See e.g., U.S. Pat. No. 4,963,405.

One difficulty with carrier tapes and cover tapes has been providing an appropriate cover tape which seals the individual components which does not somehow provide contamination of adhesive or release agent as well. The carrier tape or the cover tape must also provide some protection against the development of static electricity, which damages such fine electronic components; in fact, the winding and unwinding of the cover tape can exacerbate such problems by generating static charges. Cover tapes are often made with a static dissipative strip in the middle of the adhesive, which is derived from a vapor coated metal. This strip covers the adhesive and protects the component from the electrical discharge by bleeding off developing tribocharges. However, such strips are opaque, which means that the component cannot be viewed in its indentation, and they are quite expensive. Dispersed metals and carbon likewise introduce undesired opacity and contamination. The industry is requiring more inspection of the components while still inside the carrier tape, so transparency is becoming a most important requirement.

In U.S. Pat. No. 6,171,672, static dissipative coatings are disclosed which contain carbon, a cation, an anion, and an unspecified organopolymeric conductor. Ionic salts are not permanent coatings, and may leach out, adding to the contamination issue. Further, they are humidity dependent and can be corrosive. Further, such carbon and metals are opaque. In US Patent Publication No. 2003/0049437 cover tapes are described that include an electrically conductive coating comprising a dispersion of conductive polymer.

### SUMMARY

Disclosed herein are multi-layer cover tape constructions, carrier tape assemblies that include multi-layer cover tape constructions, and methods of making multi-layer cover tape constructions. In some embodiments the multi-layer cover tape construction comprises a first polymeric substrate with a first major surface and a second major surface, an adhesive layer coated on the first major surface of the first polymeric substrate, a low adhesion backsize coating layer on the second major surface of the first polymeric substrate, and a conductive film construction adhered to a portion of the adhesive layer such that portions of the adhesive remain exposed. The conductive film construction comprises a second polymeric substrate with a first major surface and a second major surface, where the second major surface of the second polymeric substrate is adhered to the adhesive layer, and an exposed layer of abrasion-resistant, electrically conductive nano-scale graphite particles is coated on the first major surface of the second polymeric substrate. The exposed layer of abrasion-resistant, electrically conductive nano-scale graphite particles is an optically transparent layer and has a surface resistance of less than 1×10⁵ Ohms/square, and the exposed layer of abrasion-resistant, electrically conductive nano-scale graphite particles coated on the first major surface of the second polymeric substrate is coated by buff coating.

Another embodiment of a multi-layer cover tape construction comprises a first polymeric substrate with a first major surface and a second major surface, a low adhesion backsize coating layer on the second major surface of the first polymeric substrate, and an electrically conductive coating on the first major surface of the first polymeric substrate. The conductive layer comprises an exposed layer of abrasion-resistant, electrically conductive nano-scale graphite particles coated on the first major surface of the first polymeric substrate. The exposed layer of abrasion-resistant, electrically conductive nano-scale graphite particles is an optically transparent layer and has a surface resistance of less than 1×10⁵ Ohms/square, and the exposed layer of abrasion-resistant, electrically conductive nano-scale graphite particles coated on the first major surface of the second polymeric substrate is coated by buff coating. Stripes of adhesive are present on a portion of the electrically conductive coating on the first major surface of the first polymeric substrate such that portions of the electrically conductive coating remain exposed between the adhesive stripes.

Also disclosed are embodiments of carrier tape assemblies. Some embodiments of carrier tape assemblies comprise a carrier tape for electronic component transportation, the carrier tape comprising parallel strip portions in a lengthwise direction, the strip portions having top and bottom surfaces, and between the parallel strip portions, a plurality of indented segments for accommodating electronic components formed intermittently in the lengthwise direction of the tape, and a cover tape construction for releasably sealing the indented portions of the carrier tape. The cover tape comprises a first polymeric substrate with a first major surface and a second major surface, an adhesive layer coated on the first major surface of the first polymeric substrate, a low adhesion backsize coating layer on the second major surface of the first polymeric substrate, and a conductive film construction adhered to a portion of the adhesive layer such that portions of the adhesive remain exposed. The conductive film construction comprises a second polymeric substrate with a first major surface and a second major surface, where the second major surface of the second polymeric substrate is adhered to the adhesive layer, and an exposed layer of abrasion-resistant, electrically conductive nano-scale graphite particles is coated on the first major surface of the second polymeric substrate. The exposed layer of abrasion-resistant, electrically conductive nano-scale graphite particles is an optically transparent layer and has a surface resistance of less than 1×10⁵ Ohms/square, and the exposed layer of abrasion-resistant, electrically conductive nano-scale graphite particles coated on the first major surface of the second polymeric substrate is coated by buff coating. The exposed adhesive portions are releasably adhesively bonded to the top surface of the parallel strip portions of the carrier tape.

Other embodiments of carrier tape assemblies comprise a carrier tape for electronic component transportation, the carrier tape comprising parallel strip portions in a lengthwise direction, the strip portions having top and bottom surfaces, and between the parallel strip portions, a plurality of indented segments for accommodating electronic components formed intermittently in the lengthwise direction of the tape, and a cover tape construction for releasably sealing the indented portions of the carrier tape. The cover tape construction comprises a first polymeric substrate with a first major surface and a second major surface, a low adhesion backsize coating layer on the second major surface of the first polymeric substrate, and an electrically conductive coating on the first major surface of the first polymeric substrate. The conductive layer comprises an exposed layer of abrasion-resistant, electrically conductive nano-scale graphite particles coated on the first major surface of the first polymeric substrate. The exposed layer of abrasion-resistant, electrically conductive nano-scale graphite particles is an optically transparent layer and has a surface resistance of less than 1×10⁵ Ohms/square, and the exposed layer of abrasion-resistant, electrically conductive nano-scale graphite particles coated on the first major surface of the second polymeric substrate is coated by buff coating. Stripes of adhesive are present on a portion of the electrically conductive coating on the first major surface of the first polymeric substrate such that portions of the electrically conductive coating remain exposed between the adhesive stripes.

Also disclosed are methods of forming multi-layer cover tape constructions. In some embodiments, the method of forming a multi-layer cover tape constructions comprises providing an adhesive tape construction comprising a first polymeric substrate with a first major surface and second major surface, a low adhesion backsize coating on the second major surface of the first polymeric substrate, and an adhesive layer coated on the first major surface of the first polymeric substrate. The method includes forming an electrically conductive film construction comprising providing a second polymeric substrate with a first major surface and a second major surface, applying a dry particle composition comprising graphite particles to the first major surface of the second polymeric substrate, wherein the dry particle composition comprising graphite particles comprises particles having a largest dimension of less than 100 micrometers, and comprising graphite using an applicator pad and buffing an effective amount of the graphite particles onto the surface of the polymeric substrate at a pressure normal to the surface of greater than 0 and less than about 30 grams per centimeter, where the applicator pad moves in plane parallel to the surface of the polymeric substrate in an orbital fashion. The method includes adhering the second major surface of the second polymeric substrate to the adhesive layer such that portions of the adhesive layer remain exposed on either side of the second polymeric substrate. The buff coated graphite surface on the first major surface of the second polymeric substrate is optically transparent and has a surface resistance of less than 1×10⁵ Ohms/square.

In other embodiments, the method of forming a multi-layer cover tape constructions comprises providing a first polymeric substrate with a first major surface and second major surface with a low adhesion backsize coating on the second major surface of the first polymeric substrate, and forming an electrically conductive coating on the first major surface of the first polymeric substrate. Forming an electrically conductive coating comprises applying a dry particle composition comprising graphite particles to the first major surface of the first polymeric substrate, wherein the dry particle composition comprising graphite particles comprises particles having a largest dimension of less than 100 micrometers, and comprising graphite using an applicator pad and buffing an effective amount of the graphite particles onto the surface of the polymeric substrate at a pressure normal to the surface of greater than 0 and less than about 30 grams per centimeter, where the applicator pad moves in a plane parallel to the surface of the polymeric substrate in an orbital fashion. The method includes applying adhesive stripes to a portion of the electrically conductive coating on the first major surface of the first polymeric substrate such that portions of the electrically conductive coating remain exposed between the adhesive stripes. The buff coated electrically conductive graphite surface on the first major surface of the first polymeric substrate is optically transparent and has a surface resistance of less than 1×10⁵ Ohms/square.

### BRIEF DESCRIPTION OF THE DRAWINGS

The present application may be more completely understood in consideration of the following detailed description of various embodiments of the disclosure in connection with the accompanying drawings.

FIG. 1 shows a cross-sectional view of an exemplary embodiment of a multi-layer cover tape of this disclosure.

FIG. 2 shows a cross-sectional view of an exemplary embodiment of a multi-layer cover tape of this disclosure.

FIG. 3 shows a cross-sectional view of an exemplary embodiment of a multi-layer carrier tape construction of this disclosure.

In the following description of the illustrated embodiments, reference is made to the accompanying drawings, in which is shown by way of illustration, various embodiments in which the disclosure may be practiced. It is to be understood that the embodiments may be utilized and structural changes may be made without departing from the scope of the present disclosure. The figures are not necessarily to scale Like numbers used in the figures refer to like components. However, it will be understood that the use of a number to refer to a component in a given figure is not intended to limit the component in another figure labeled with the same number.

### DETAILED DESCRIPTION

As electronic parts have become more miniature, storage, transportation and handling of such components has become more difficult, and specialized methods have evolved. One such method is use of a carrier tape. A carrier tape can be formed of a variety of materials, but are typically a plastic material formed in a strip which has multiple longitudinal recesses or indentions meant to hold individual components to prevent them from touching each other or being otherwise exposed to trauma. Such indented segments must have an upper opening by which the component is placed into the recess, and then the opening must be sealed, generally by means of a cover tape.

A number of specialized features are required of the cover tape constructions, beyond the typical properties common to tapes, such as optical clarity to permit viewing into the indented portions of the carrier tape, and an electrically conductive surface layer on the cover tape surface to prevent tribocharging when the tape is attached or removed from the carrier tape. Additionally, it is desirable that the coating to provide this conductivity to the cover tape surface be scratch resistant and of sufficient hardness that the coating is not rubbed off during processing, as any material that flakes off from the coating can contaminate the electronic components that the cover tape is designed to protect. An additional feature that is unique to constructions of this type is what will be called “abrasion resistance” in this disclosure. This feature will be described in detail below, but refers in general to the property of preventing oozing of adhesive through the film layer if the film layer becomes abraded. Yet another contradictory property desired of these coatings is the need that the coating be sufficiently flexible to be rolled up in the form of a roll, and also of sufficiently low surface energy that the coating permits the rolled up cover tape to be unrolled, and also that the coating does not adhere to the surface of the electronic components carried by the carrier tape if the coating comes in contact with the electronic components.

A variety of coatings have been used to try to fulfill all of these features. One method for achieving the desired conductivity, flexibility and optical clarity is to use a very thin layer of metal. However, since metals are subject to corrosion, the layer of metal must be protected by an overcoat, typically a polymeric overcoat that is itself optically transparent and able to provide not only protection to the metal layer but also potentially can provide other desirable features to the coating, for example hardness, low surface energy. However, since the conductive coating is a two layer coating, two coating processes need to be carried out to produce the coated articles. This not only is inconvenient and expensive, it also doubles the opportunities for problems to occur in the coatings. Additionally, since the metal coating is the conductive coating, placing a polymeric coating over the conductive metal layer can reduce the conductivity of this coating and thus the ability of the coating to dissipate static charge. This is the case because, typically, the protective polymeric coating has an insulating effect. Also, because two coatings with very different properties (a metal layer and a polymeric overcoat) are present, care must be exercised to balance the competing properties of enhancing conductivity (with a thin overcoat) and yet maintaining the desirable protective features provided by the overcoat such as protecting the metal layer from corrosion, giving the surface the desired low surface energy, abrasion resistance, etc desired for the tape construction. Thus a single coating, where that coating is exposed, that can provide the desirable features of high surface conductivity, optical clarity, abrasion resistance, and low surface energy, is desirable for cover tapes useful in carrier tape constructions.

In this disclosure, cover tapes, carrier tape constructions and methods of making them will be described that incorporate a conductive film which comprises a polymeric substrate with an exposed layer of abrasion-resistant, electrically conductive nano-scale graphite particles coated on the polymeric substrate, where the exposed layer of abrasion-resistant, electrically conductive nano-scale graphite particles is an optically transparent layer and has a surface resistance of less than 1×10⁵ Ohms/square. The exposed layer of abrasion-resistant, electrically conductive nano-scale graphite particles coated on the polymeric substrate is coated by buff coating.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a layer” encompasses embodiments having one, two or more layers. As used in this specification and the appended claims, the term “or” is generally employed in its sense including “and/or” unless the content clearly dictates otherwise.

The term “adhesive” as used herein refers to polymeric compositions useful to adhere together two adherends. Examples of adhesives are heat activated adhesives and pressure sensitive adhesives.

Heat activated adhesives are non-tacky at room temperature but become tacky and capable of bonding to a substrate at elevated temperatures. These adhesives usually have a T_{g} (glass transition temperature) or melting point (Tₘ) above room temperature. When the temperature is elevated above the T_{g} or Tₘ, the storage modulus usually decreases and the adhesive becomes tacky.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

Unless otherwise indicated, “optically transparent” refers to an article, film or adhesive composition that has a high light transmittance over at least a portion of the visible light spectrum (about 400 to about 700 nm).

Unless otherwise indicated, “optically clear” refers to an adhesive or article that has a high light transmittance over at least a portion of the visible light spectrum (about 400 to about 700 nm), and that exhibits low haze. The term “haze” refers to that percentage of transmitted light that deviates from the incident beam by more than 2.5° on the average.

As used herein, the term “conductivity” means a measure of the ability of electrical charge to move within a material. “Resistivity” is the reciprocal of conductivity.

As used herein, the term “cover tape” means a tape useful for sticking to the surface of a carrier tape, which has indented segments for accommodating and transporting chips and other sensitive electronic components.

As used herein, the term “indented segments” refers to individual carriers, e.g., pockets or cups formed in the carrier tape to hold typically a single unit of some product. Such segments are typically formed by vacuum forming, thermoforming, molding or other known process.

As used herein, the term “strip portion” refers to that portion of the carrier tape along each longitudinal edge, which may or may not have sprocket holes for winding.

The term “adjacent” as used herein when referring to two layers means that the two layers are in proximity with one another with no intervening open space between them. They may be in direct contact with one another (e.g. laminated together) or there may be intervening layers.

The term “nano-scale” as used herein when used to describe particles, refers to particles in which the largest dimension of the particle is less than 500 nanometers.

All percentages, ratios and amounts herein are by weight unless otherwise specifically noted.

In this disclosure, cover tapes, carrier tape constructions and methods of making them will be described that incorporate a conductive film which comprises a polymeric substrate with an exposed layer of abrasion-resistant, electrically conductive nano-scale graphite particles coated on the polymeric substrate, where the exposed layer of abrasion-resistant, electrically conductive nano-scale graphite particles is an optically transparent layer and has a surface resistance of less than 1×10⁵ Ohms/square. The exposed layer of abrasion-resistant, electrically conductive nano-scale graphite particles coated on the polymeric substrate is coated by buff coating. The cover tapes, carrier tapes and the methods used to prepare and use them are described in greater detail below.

Disclosed herein are two different types of cover tape constructions. The first type is a multi-layer cover tape construction that comprises at least two polymeric substrates. The second type of multi-layer cover tape construction comprises a single polymeric substrate.

The first type of multi-layer cover tape construction comprises a first polymeric substrate with a first major surface and a second major surface, an adhesive layer coated on the first major surface of the first polymeric substrate, a low adhesion backsize coating layer on the second major surface of the first polymeric substrate and a conductive film construction adhered to a portion of the adhesive layer such that portions of the adhesive remain exposed. The conductive film construction comprises a second polymeric substrate with a first major surface and a second major surface, where the second major surface of the second polymeric substrate is adhered to the adhesive layer, and an exposed layer of abrasion-resistant, electrically conductive nano-scale graphite particles is coated on the first major surface of the second polymeric substrate. The exposed layer of abrasion-resistant, electrically conductive nano-scale graphite particles is an optically transparent layer and has a surface resistance of less than 1×10⁵ Ohms/square. The exposed layer of abrasion-resistant, electrically conductive nano-scale graphite particles coated on the first major surface of the second polymeric substrate is coated by buff coating.

A wide range of materials are suitable for use in the first and second polymeric substrates of the cover tape constructions of this disclosure. The polymeric substrates are typically films prepared from polymeric materials, either a single polymeric material or a blend of polymeric materials. Because optical transparency is a desired feature of the cover tape constructions, typically the first and second polymeric substrates are optically transparent or optically clear. The first and second polymeric substrates may be prepared from the same polymeric materials or from different polymeric materials. Suitable polymeric materials include a wide range of polymeric materials that are typically used in tape constructions as backing materials. Examples of suitable materials include: polyesters, such as for example polyethylene terephthalate (PET), and polyester copolymers; polyolefins, such as polyethylene (PE, including a wide range of grades of polyethylene such as low density polyethylene LDPE) and polyethylene copolymers, polypropylene (PP, including biaxially oriented polypropylene BOPP), and polyolefin copolymers; polyurethanes, including polyurethane copolymers; polyacrylate polymers and copolymers; polyvinyl polymers and copolymers; polymethylmethacrylate polymers and copolymers; polycarbonate polymers and copolymers; and combinations and mixtures thereof.

The first and second polymeric substrates may be of any suitable thickness. Typically the substrates are in the range of from about 5 micrometers (0.2 mils) to about 100 micrometers (4 mils), more typically the substrates are in the range of from about 6 micrometers (0.25 mils) to about 32 micrometers (1.25 mils), or even 13 micrometers (0.5 mils) to 25 micrometers (1.0 mils).

A wide range of adhesive layers are suitable to be disposed upon the first major surface of the first polymeric substrate. Particularly suitable adhesives are heat activated adhesives and pressure sensitive adhesives.

If desired, an optional primer layer can be used. Such a primer layer would be located between the first major surface of the first polymeric substrate and the adhesive. Primer layers are well known coatings suitable for increasing the adhesion between layers. In this instance, the primer layer increases the adhesion between the polymeric substrate and the adhesive. A wide variety of primers are suitable. Typically a tape construction comprising an adhesive layer and a backing layer, is adhered to a substrate. When the tape construction is removed from the substrate, if the adhesive bond between the adhesive and the substrate is stronger than the bond between the adhesive and the backing, rather than the adhesive and backing being peeled away from the substrate, the backing can be peeled away from the adhesive, leaving the adhesive adhered to the substrate surface. The use of a primer can help to eliminate this phenomenon, by increasing the strength of the backing/adhesive bond.

If used, the nature of the primer layer will depend upon the composition of the polymeric substrate as well as the composition of the adhesive. For example, a number of primer technologies that have been used to provide improved adhesion between polyester-based substrates and functional coatings, such as adhesive layers, applied to them are: the use of aminosilane coatings to improve the adhesion at subfreezing temperatures as described in U.S. Pat. No. 5,064,722 (Swofford et al.); PET (polyethylene terephthalate) films primed with polyallylamine coatings to improve adhesion to the PET film of a polyvinyl butyral or ionoplast resin layer, as described in U.S. Pat. No. 7,189,457 (Anderson); glass laminates for reduction of sound transmission that may include 3-layer laminates of polyester film positioned between two dissimilar polymer layers, as described in U.S. Pat. No. 7,297,407 (Anderson); and the primer layers for multi-layer optical films where the primer layer may include a sulfopolyester and a crosslinker, as described in PCT Publication No. WO 2009/123921.

Heat activated adhesives are non-tacky at room temperature but become tacky and capable of bonding to a substrate at elevated temperatures. These adhesives usually have a T_{g} (glass transition temperature) or melting point (Tₘ) above room temperature. When the temperature is elevated above the T_{g} or Tₘ, the storage modulus usually decreases and the adhesive becomes tacky.

Typically, because it is desirable that the cover tape construction be optically transparent or optically clear, the heat activated adhesive is optically transparent or optically clear. A wide variety of optically clear heat activated adhesives may be used. Examples of suitable optically clear heat activated adhesives include polyacrylate hot melt adhesives, polyvinyl butyrals, ethylene vinyl acetate, ionomers, polyolefins, or combinations thereof.

The optically clear heat activated adhesives may be (meth)acrylate-based hot melt adhesives. The hot melt adhesives typically are prepared from (meth)acrylate polymers that have a glass transition temperature (Tg) of greater than room temperature, more typically greater than about 40° C., and are prepared from alkyl (meth)acrylate monomers. Useful alkyl (meth)acrylates (i.e., acrylic acid alkyl ester monomers) include linear or branched monofunctional unsaturated acrylates or methacrylates of non-tertiary alkyl alcohols, the alkyl groups of which have from 4 to 14 and, in particular, from 4 to 12 carbon atoms. Poly(meth)acrylic hot melt adhesives may also contain optional co-monomer components such as, for example, (meth)acrylic acid, vinyl acetate, N-vinyl pyrrolidone, (meth)acrylamide, a vinyl ester, a fumarate, a styrene macromer, alkyl maleates and alkyl fumarates (based, respectively, on maleic and fumaric acid), or combinations thereof.

In some embodiments, the adhesive layer is at least partially formed of polyvinyl butyral. The polyvinyl butyral layer may be formed via known aqueous or solvent-based acetalization process in which polyvinyl alcohol is reacted with butyraldehyde in the presence of an acidic catalyst. In some instances, the polyvinyl butyral layer may include or be formed from polyvinyl butyral that is commercially available from Solutia Incorporated, of St. Louis, Mo., under the trade name “BUTVAR” resin.

In some instances, the polyvinyl butyral layer may be produced by mixing resin and (optionally) plasticizer and extruding the mixed formulation through a sheet die. If a plasticizer is included, the polyvinyl butyral resin may include about 20 to 80 or perhaps about 25 to 60 parts of plasticizer per hundred parts of resin. Examples of suitable plasticizers include esters of a polybasic acid or a polyhydric alcohol. Suitable plasticizers are triethylene glycol bis(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyl adipate, mixtures of heptyl and nonyl adipates, diisononyl adipate, heptylnonyl adipate, dibutyl sebacate, polymeric plasticizers such as the oil-modified sebacic alkyds, and mixtures of phosphates and adipates such as disclosed in U.S. Pat. No. 3,841,890 and adipates such as disclosed in U.S. Pat. No. 4,144,217.

Examples of suitable ethylene vinyl acetate (EVA) adhesives include a wide range of commercially available EVA hot melt adhesives. Typically these EVA hot melt adhesives have a vinyl acetate content of from about 18-29% by weight of the polymer. The adhesives typically have high amounts of tackifiers and waxes. An exemplary composition is one with 30-40% by weight of EVA polymer, 30-40% by weight of tackifier, 20-30% by weight of wax, and 0.5-1% by weight of stabilizers. Examples of suitable EVA hot melt adhesives are the BYNEL SERIES 3800 resins commercially available from DuPont, Wilmington, Del. (including BYNEL 3810, BYNEL 3859, BYNEL 3860, and BYNEL 3861). A particularly suitable EVA hot melt adhesive is the material available from Bridgestone Corp. Tokyo, JP under the trade name “EVASAFE”.

Examples of suitable ionomeric adhesives are the “ionoplast resins”. Ionoplast resins are copolymers of ethylene and unsaturated carboxylic acids, wherein at least a portion of the acid groups in the copolymer have been neutralized to the salt form of the acid. Extruded sheets of ionoplast resins suitable for use in this disclosure are commercially available from DuPont Chemicals, Wilmington, Del., under the trade name “SENTRYGLASS PLUS”.

Examples of suitable polyolefin adhesives include ethylene/α-olefin copolymers. As used herein, the term “ethylene/α-olefin copolymer” refers to polymers comprising a class of hydrocarbons manufactured by the catalytic oligomerization (i.e., polymerization to low-molecular-weight products) of ethylene and linear α-olefin monomers. The ethylene/α-olefin copolymers may be made, for example, with a single site catalyst such as a metallocene catalyst or multi-site catalysts such as Ziegler-Natta and Phillips catalysts. The linear α-olefin monomers typically are 1-butene or 1-octene but may range from C3 to C20 linear, branched or cyclic α-olefin. The α-olefin may be branched but only if the branch is at least alpha to the double bond, such as 3-methyl-1-pentene. Examples of C3-C20 α-olefins include propylene, 1-butene, 4-methyl-1-butene, 1-hexene, 1-octene, 1-dodecene, 1-tetradecene, 1-hexadecene and 1-octadecene. The α-olefins can also contain a cyclic structure such as cyclohexane or cyclopentane, resulting in an α-olefin such as 3-cyclohexyl-1 propene (allyl cyclohexane) and vinyl cyclohexane. Although not α-olefins in the classical sense of the term, for purposes of this disclosure certain cyclic olefins, such as norbornene and related olefins, are α-olefins and can be used. Similarly, styrene and its related olefins (for example, α-methyl styrene) are α-olefins for the purposes of this disclosure. Acrylic and methacrylic acid and their respective ionomers, and acrylates and methacrylates, however are not α-olefins for the purposes of this disclosure. Illustrative ethylene/α-olefin copolymers include ethylene/1-butene, ethylene/1-octene, ethylene/1-butene/1-octene, ethylene/styrene. The polymers can be block or random. Exemplary commercially available low crystalline ethylene/α-olefin copolymers include resins sold under the tradenames “ENGAGE” ethylene/1-butene and ethylene/1-octene copolymers and “FLEXOMER” ethylene/1-hexene copolymer, available from Dow Chemical Co., and homogeneously branched, substantially linear ethylene/α-olefin copolymers such as “TAFMER”, available from Mitsui Petrochemicals Company Limited, and “EXACT”, available from ExxonMobil Corp. As used herein, the term “copolymer” refers to polymers made from at least 2 monomers.

In some of these embodiments, the α-olefin moiety of the ethylene/α-olefin copolymer includes four or more carbons. In some embodiments, the ethylene/α-olefin copolymer is a low crystalline ethylene/α-olefin copolymer. As used herein, the term “low crystalline” means crystallinity (according to method disclosed in ASTM F2625-07) of less than 50% by weight. In some embodiments, the low crystalline ethylene/α-olefin copolymer is a butene α-olefin. In some embodiments the α-olefin of the low crystalline ethylene/α-olefin copolymer has 4 or more carbons.

In some embodiments, the low crystalline ethylene/α-olefin copolymer has a DSC peak melting point of less than or equal to 50° C. As used herein, the term “DSC peak melting point” means a melting point determined by DSC (10°/min) under nitrogen purge as the peak with the largest area under the DSC curve.

In some embodiments, the adhesive is a pressure sensitive adhesive. Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. A wide range of pressure sensitive adhesives are suitable for use in the cover tape constructions of this disclosure.

Suitable pressure sensitive adhesives include those based on natural rubbers, synthetic rubbers, styrene block copolymers, polyvinyl ethers, (meth)acrylates, poly-α-olefins, silicones, urethanes or ureas. As with the heat activated adhesives described above, typically the pressure sensitive adhesive is optically transparent or optically clear.

Useful natural rubber pressure sensitive adhesives generally contain masticated natural rubber, from 25 parts to 300 parts of one or more tackifying resins to 100 parts of natural rubber, and typically from 0.5 to 2.0 parts of one or more antioxidants. Natural rubber may range in grade from a light pale crepe grade to a darker ribbed smoked sheet and includes such examples as CV-60, a controlled viscosity rubber grade and SMR-5, a ribbed smoked sheet rubber grade.

Tackifying resins used with natural rubbers generally include but are not limited to wood rosin and its hydrogenated derivatives; terpene resins of various softening points, and petroleum-based resins, such as, the “ESCOREZ 1300” series of C5 aliphatic olefin-derived resins from Exxon, and “PICCOLYTE S” series, polyterpenes from Hercules, Inc. Antioxidants are used to retard the oxidative attack on natural rubber, which can result in loss of the cohesive strength of the natural rubber adhesive. Useful antioxidants include but are not limited to amines, such as N—N′ di-β-naphthyl-1,4-phenylenediamine, available as “AGERITE D”; phenolics, such as 2,5-di-(t-amyl) hydroquinone, available as “SANTOVAR A”, available from Monsanto Chemical Co., tetrakis [methylene 3-(3′,5′-di-tert-butyl-4′-hydroxyphenyl)propianate]methane, available as “IRGANOX 1010” from Ciba-Geigy Corp., and 2-2′-methylenebis(4-methyl-6-tert butyl phenol), available as Antioxidant 2246; and dithiocarbamates, such as zinc dithiodibutyl carbamate. Other materials can be added to natural rubber adhesives for special purposes, wherein the additions can include plasticizers, pigments, and curing agents to partially vulcanize the pressure sensitive adhesive.

Another useful class of pressure sensitive adhesives are those comprising synthetic rubber. Such adhesives are generally rubbery elastomers, which are either self-tacky or non tacky and require tackifiers.

Self-tacky synthetic rubber pressure sensitive adhesives include for example, butyl rubber, a copolymer of isobutylene with less than 3 percent isoprene, polyisobutylene, a homopolymer of isoprene, polybutadiene, such as “TAKTENE 220 BAYER” or styrene/butadiene rubber. Butyl rubber pressure sensitive adhesives often contain an antioxidant such as zinc dibutyl dithiocarbamate. Polyisobutylene pressure sensitive adhesives do not usually contain antioxidants. Synthetic rubber pressure sensitive adhesives, which generally require tackifiers, are also generally easier to melt process. They comprise polybutadiene or styrene/butadiene rubber, from 10 parts to 200 parts of a tackifier, and generally from 0.5 to 2.0 parts per 100 parts rubber of an antioxidant such as “IRGANOX 1010”. An example of a synthetic rubber is “AMERIPOL 1011A”, a styrene/butadiene rubber available from BF Goodrich. Tackifiers that are useful include derivatives of rosins such as “FORAL 85”, a stabilized rosin ester from Hercules, Inc., the “SNOWTACK” series of gum rosins from Tenneco, and the “AQUATAC” series of tall oil rosins from Sylvachem; and synthetic hydrocarbon resins such as the “PICCOLYTE A” series, polyterpenes from Hercules, Inc., the “ESCOREZ 1300” series of C5 aliphatic olefin-derived resins, the “ESCOREZ 2000” Series of C₉ aromatic/aliphatic olefin-derived resins, and polyaromatic C₉ resins, such as the “PICCO 5000” series of aromatic hydrocarbon resins, from Hercules, Inc. Other materials can be added for special purposes, including hydrogenated butyl rubber, pigments, plasticizers, liquid rubbers, such as “VISTANEX LMMH” polyisobutylene liquid rubber available from Exxon, and curing agents to vulcanize the adhesive partially.

Styrene block copolymer pressure sensitive adhesives generally comprise elastomers of the A-B or A-B-A type, where A represents a thermoplastic polystyrene block and B represents a rubbery block of polyisoprene, polybutadiene, or poly(ethylene/butylene), and resins. Examples of the various block copolymers useful in block copolymer pressure sensitive adhesives include linear, radial, star and tapered styrene-isoprene block copolymers such as “KRATON D1107P”, available from Shell Chemical Co., and “EUROPRENE SOL TE 9110”, available from EniChem Elastomers Americas, Inc.; linear styrene-(ethylene-butylene) block copolymers such as “KRATON G1657”, available from Shell Chemical Co.; linear styrene-(ethylene-propylene) block copolymers such as “KRATON G1750X”, available from Shell Chemical Co.; and linear, radial, and star styrene-butadiene block copolymers such as “KRATON D1118X”, available from Shell Chemical Co., and “EUROPRENE SOL TE 6205”, available from EniChem Elastomers Americas, Inc. The polystyrene blocks tend to form domains in the shape of spheroids, cylinders, or plates that causes the block copolymer pressure sensitive adhesives to have two phase structures. Resins that associate with the rubber phase generally develop tack in the pressure sensitive adhesive. Examples of rubber phase associating resins include aliphatic olefin-derived resins, such as the “ESCOREZ 1300” series and the “WINGTACK” series, available from Goodyear; rosin esters, such as the “FORAL” series and the “STAYBELITE” Ester 10, both available from Hercules, Inc.; hydrogenated hydrocarbons, such as the “ESCOREZ 5000” series, available from Exxon; polyterpenes, such as the “PICCOLYTE A” series; and terpene phenolic resins derived from petroleum or terpentine sources, such as “PICCOFYN A100”, available from Hercules, Inc. Resins that associate with the thermoplastic phase tend to stiffen the pressure sensitive adhesive. Thermoplastic phase associating resins include polyaromatics, such as the “PICCO 6000” series of aromatic hydrocarbon resins, available from Hercules, Inc.; coumarone-indene resins, such as the “CUMAR” series, available from Neville; and other high-solubility parameter resins derived from coal tar or petroleum and having softening points above about 85° C., such as the “AMOCO 18” series of alphamethyl styrene resins, available from Amoco, “PICCOVAR 130” alkyl aromatic polyindene resin, available from Hercules, Inc., and the “PICCOTEX” series of alphamethyl styrene/vinyl toluene resins, available from Hercules. Other materials can be added for special purposes, including rubber phase plasticizing hydrocarbon oils, such as, “TUFFLO 6056”, available from Lydondell Petrochemical Co., Polybutene-8 from Chevron, “KAYDOL”, available from Witco, and “SHELLFLEX 371”, available from Shell Chemical Co.; pigments; antioxidants, such as “IRGANOX 1010” and “IRGANOX 1076”, both available from Ciba-Geigy Corp., “BUTAZATE”, available from Uniroyal Chemical Co., “CYANOX LDTP”, available from American Cyanamid, and “BUTASAN”, available from Monsanto Co.; antiozonants, such as “NBC”, a nickel dibutyldithiocarbamate, available from DuPont; liquid rubbers such as “VISTANEX LMMH” polyisobutylene rubber; and ultraviolet light inhibitors, such as “IRGANOX 1010” and “TINUVIN P”, available from Ciba-Geigy Corp.

Polyvinyl ether pressure sensitive adhesives are generally blends of homopolymers of vinyl methyl ether, vinyl ethyl ether or vinyl iso-butyl ether, or blends of homopolymers of vinyl ethers and copolymers of vinyl ethers and acrylates to achieve desired pressure sensitive properties. Depending on the degree of polymerization, homopolymers may be viscous oils, tacky soft resins or rubber-like substances. Polyvinyl ethers used as raw materials in polyvinyl ether adhesives include polymers based on: vinyl methyl ether such as “LUTANOL M 40”, available from BASF, and “GANTREZ M 574” and “GANTREZ 555”, available from ISP Technologies, Inc.; vinyl ethyl ether such as “LUTANOL A 25”, “LUTANOL A 50” and “LUTANOL A 100”; vinyl isobutyl ether such as “LUTANOL 130”, “LUTANOL 160”, “LUTANOL IC”, “LUTANOL I60D” and “LUTANOL I 65D”; methacrylate/vinyl isobutyl ether/acrylic acid such as “ACRONAL 550 D”, available from BASF. Antioxidants useful to stabilize the polyvinylether pressure sensitive adhesive include, for example, “IONOX 30” available from Shell, “IRGANOX 1010” available from Ciba-Geigy, and antioxidant “ZKF” available from Bayer Leverkusen. Other materials can be added for special purposes as described in BASF literature including tackifier, plasticizer and pigments.

(Meth)acrylate-based pressure sensitive adhesives generally have a glass transition temperature of about −20° C. or less and may comprise from 100 to 80 weight percent of a C₃-C₁₂ alkyl ester component such as, for example, isooctyl acrylate, 2-ethyl-hexyl acrylate and n-butyl acrylate and from 0 to 20 weight percent of a polar component such as, for example, acrylic acid, methacrylic acid, ethylene vinyl acetate, N-vinyl pyrrolidone and styrene macromer. Generally, the (meth)acrylate-based pressure sensitive adhesives comprise from 0 to 20 weight percent of acrylic acid and from 100 to 80 weight percent of isooctyl acrylate. The (meth)acrylate-based pressure sensitive adhesives may be self-tacky or tackified. Useful tackifiers for acrylics are rosin esters such as “FORAL 85”, available from Hercules, Inc., aromatic resins such as “PICCOTEX LC-55WK”, aliphatic resins such as “PICCOTAC 95”, available from Hercules, Inc., and terpene resins such as α-pinene and β-pinene, available as “PICCOLYTE A-115” and “ZONAREZ B-100” from Arizona Chemical Co. Other materials can be added for special purposes, including hydrogenated butyl rubber, pigments, and curing agents to vulcanize the adhesive partially.

Poly-α-olefin pressure sensitive adhesives, also called a poly(l-alkene) pressure sensitive adhesives, generally comprise either a substantially uncrosslinked polymer or a uncrosslinked polymer that may have radiation activatable functional groups grafted thereon as described in U.S. Pat. No. 5,209,971 (Babu, et al) which is incorporated herein by reference. The poly-α-olefin polymer may be self tacky and/or include one or more tackifying materials. If uncrosslinked, the inherent viscosity of the polymer is generally between about 0.7 and 5.0 dL/g as measured by ASTM D 2857-93, “Standard Practice for Dilute Solution Viscosity of Polymers”. In addition, the polymer generally is predominantly amorphous. Useful poly-α-olefin polymers include, for example, C₃-C₁₈ poly(l-alkene) polymers, generally C₅-C₁₂ α-olefins and copolymers of those with C₃ or C₆-C₈ and copolymers of those with C₃. Tackifying materials are typically resins that are miscible in the poly-α-olefin polymer. The total amount of tackifying resin in the poly-α-olefin polymer ranges between 0 to 150 parts by weight per 100 parts of the poly-α-olefin polymer depending on the specific application. Useful tackifying resins include resins derived by polymerization of C₅ to C₉ unsaturated hydrocarbon monomers, polyterpenes, synthetic polyterpenes and the like. Examples of such commercially available resins based on a C₅ olefin fraction of this type are “WINGTACK 95” and “WINGTACK 15” tackifying resins available from Goodyear Tire and Rubber Co. Other hydrocarbon resins include “REGALREZ 1078” and “REGALREZ 1126” available from Hercules Chemical Co., and “ARKON P115” available from Arakawa Chemical Co. Other materials can be added for special purposes, including antioxidants, fillers, pigments, and radiation activated crosslinking agents.

Silicone pressure sensitive adhesives comprise two major components, a polymer or gum, and a tackifying resin. The polymer is typically a high molecular weight polydimethylsiloxane or polydimethyldiphenylsiloxane, that contains residual silanol functionality (SiOH) on the ends of the polymer chain, or a block copolymer comprising polydiorganosiloxane soft segments and urea terminated hard segments. The tackifying resin is generally a three-dimensional silicate structure that is endcapped with trimethylsiloxy groups (OSiMe₃) and also contains some residual silanol functionality. Examples of tackifying resins include SR 545, from General Electric Co., Silicone Resins Division, Waterford, N.Y., and MQD-32-2 from Shin-Etsu Silicones of America, Inc., Torrance, Calif. Manufacture of typical silicone pressure sensitive adhesives is described in U.S. Pat. No. 2,736,721 (Dexter). Manufacture of silicone urea block copolymer pressure sensitive adhesive is described in U.S. Pat. No. 5,214,119 (Leir, et al). Other materials can be added for special purposes, including, pigments, plasticizers, and fillers. Fillers are typically used in amounts from 0 parts to 10 parts per 100 parts of silicone pressure sensitive adhesive. Examples of fillers that can be used include zinc oxide, silica, carbon black, pigments, metal powders and calcium carbonate. One suitable class of siloxane-containing pressure sensitive adhesives are those with oxamide terminated hard segments such as those described in U.S. Pat. No. 7,981,995 (Hays) and U.S. Pat. No. 7,371,464 (Sherman).

Useful polyurethane and polyurea pressure sensitive adhesives useful include, for example, those disclosed in WO 00/75210 (Kinning et al.) and in U.S. Pat. No. 3,718,712 (Tushaus); U.S. Pat. No. 3,437,622 (Dahl); and U.S. Pat. No. 5,591,820 (Kydonieus et al.). Additionally, the urea-based pressure sensitive adhesives described in US Patent Publication No. 2011/0123800 (Sherman et al.) and the urethane-based pressure sensitive adhesives described in US Patent Publication No. 2012/0100326 (Sherman et al.) may be suitable.

One particularly suitable class of optically clear pressure sensitive adhesives are (meth)acrylate-based pressure sensitive adhesives and may comprise either an acidic or basic copolymer. In many embodiments the (meth)acrylate-based pressure sensitive adhesive is an acidic copolymer. Generally, as the proportion of acidic monomers used in preparing the acidic copolymer increases, cohesive strength of the resulting adhesive increases. The proportion of acidic monomers is usually adjusted depending on the proportion of acidic copolymer present in the blends of the present disclosure.

To achieve pressure sensitive adhesive characteristics, the corresponding copolymer can be tailored to have a resultant glass transition temperature (Tg) of less than about 0° C. Particularly suitable pressure sensitive adhesive copolymers are (meth)acrylate copolymers. Such copolymers typically are derived from monomers comprising about 40% by weight to about 98% by weight, often at least 70% by weight, or at least 85% by weight, or even about 90% by weight, of at least one alkyl (meth)acrylate monomer that, as a homopolymer, has a Tg of less than about 0° C.

Examples of such alkyl (meth)acrylate monomers are those in which the alkyl groups comprise from about 4 carbon atoms to about 12 carbon atoms and include, but are not limited to, n-butyl acrylate, 2-ethylhexyl acrylate, isooctyl acrylate, isononyl acrylate, isodecyl acrylate, and mixtures thereof. Optionally, other vinyl monomers and alkyl (meth)acrylate monomers which, as homopolymers, have a Tg greater than 0° C., such as methyl acrylate, methyl methacrylate, isobornyl acrylate, vinyl acetate, styrene, and the like, may be utilized in conjunction with one or more of the low Tg alkyl (meth)acrylate monomers and copolymerizable basic or acidic monomers, provided that the Tg of the resultant (meth)acrylate copolymer is less than about 0° C.

In some embodiments, it is desirable to use (meth)acrylate monomers that are free of alkoxy groups. Alkoxy groups are understood by those skilled in the art.

When used, basic (meth)acrylate copolymers useful as the pressure sensitive adhesive matrix typically are derived from basic monomers comprising about 2% by weight to about 50% by weight, or about 5% by weight to about 30% by weight, of a c op olymerizable basic monomer. Exemplary basic monomers include N,N-dimethylaminopropyl methacrylamide (DMAPMAm); N,N-diethylaminopropyl methacrylamide (DEAPMAm); N,N-dimethylaminoethyl acrylate (DMAEA); N,N-diethylaminoethyl acrylate (DEAEA); N,N-dimethylaminopropyl acrylate (DMAPA); N,N-diethylaminopropyl acrylate (DEAPA); N,N-dimethylaminoethyl methacrylate (DMAEMA); N,N-diethylaminoethyl methacrylate (DEAEMA); N,N-dimethylaminoethyl acrylamide (DMAEAm); N,N-dimethylaminoethyl methacrylamide (DMAEMAm); N,N-diethylaminoethyl acrylamide (DEAEAm); N,N-diethylaminoethyl methacrylamide (DEAEMAm); N,N-dimethylaminoethyl vinyl ether (DMAEVE); N,N-diethylaminoethyl vinyl ether (DEAEVE); and mixtures thereof. Other useful basic monomers include vinylpyridine, vinylimidazole, tertiary amino-functionalized styrene (e.g., 4-(N,N-dimethylamino)-styrene (DMAS), 4-(N,N-diethylamino)-styrene (DEAS)), N-vinylpyrrolidone, N-vinylcaprolactam, acrylonitrile, N-vinylformamide, (meth)acrylamide, and mixtures thereof.

When used to form the pressure sensitive adhesive matrix, acidic (meth)acrylate copolymers typically are derived from acidic monomers comprising about 2% by weight to about 30% by weight, or about 2% by weight to about 15% by weight, of a copolymerizable acidic monomer. Useful acidic monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, beta-carboxyethyl acrylate, 2-sulfoethyl methacrylate, styrenesulfonic acid, 2-acrylamido-2-methylpropanesulfonic acid, vinylphosphonic acid, and the like, and mixtures thereof. Due to their availability, typically ethylenically unsaturated carboxylic acids are used.

In certain embodiments, the poly(meth)acrylic pressure sensitive adhesive matrix is derived from between about 1 and about 20 weight percent of acrylic acid and between about 99 and about 80 weight percent of at least one of isooctyl acrylate, 2-ethylhexyl acrylate or n-butyl acrylate composition. In some embodiments, the pressure sensitive adhesive matrix is derived from between about 2 and about 10 weight percent acrylic acid and between about 90 and about 98 weight percent of at least one of isooctyl acrylate, 2-ethylhexyl acrylate or n-butyl acrylate composition.

Another useful class of optically clear (meth)acrylate-based pressure sensitive adhesives are those which are (meth)acrylic block copolymers. Such copolymers may contain only (meth)acrylate monomers or may contain other co-monomers such as styrenes. Examples of such pressure sensitive adhesives are described, for example in U.S. Pat. No. 7,255,920 (Everaerts et al.).

The second major surface of the first polymeric substrate contains a release coating layer. A wide range of release coating layers are suitable to be disposed upon the second major surface of the first polymeric substrate. Particularly suitable release coatings include materials such as is used on the back side of rolled tape products to permit the tape to be rolled up and remain intact and then to be unwound for use. Such materials are sometimes called Low Adhesion Backsizes or LABs. A wide variety of LABs have been developed for use with a wide variety of adhesives. Examples of suitable LAB or release coatings that are suitable for use in the cover tape constructions of this disclosure include: the water-based fluorochemical materials described in U.S. Pat. No. 7,411,020 (Carlson et al.); the polysiloxane release coatings described in U.S. Pat. No. 5,753,346 (Leir et al.); the release compositions describe in U.S. Pat. No. 7,229,687 (Kinning et al.); the polyvinyl N-alkyl carbamates (polyurethanes) described in U.S. Pat. No. 2,532,011 (Dalquist et al.); the moisture-curable materials described in U.S. Pat. No. 6,204,350 (Liu et al.); and the organopolysiloxane-poyurea copolymer release agents described in U.S. Pat. No. 5,290,615 (Tushaus et al.).

The first type of cover tape constructions of this disclosure also includes a conductive film construction. This conductive film construction includes a second polymeric substrate with a first major surface and a second major surface, where the second major surface of the second polymeric substrate is adhered to the adhesive layer described above, such that portions of the adhesive remain exposed, as will be discussed in greater detail below. The first major surface of the second polymeric construction comprises an exposed layer of abrasion-resistant, electrically conductive nano-scale graphite particles coated on the first major surface of the second polymeric substrate. The exposed layer of abrasion-resistant, electrically conductive nano-scale graphite particles is an optically transparent layer and has a surface resistance of less than 1×10⁵ Ohms/square. The exposed layer of abrasion-resistant, electrically conductive nano-scale graphite particles coated on the first major surface of the second polymeric substrate is coated by buff coating.

The exposed layer of abrasion-resistant, electrically conductive nano-scale graphite particles has a wide range of desirable properties making it particularly suitable for the cover tape constructions of this disclosure.

The exposed layer is not sensitive to exposure to the environment, unlike for example, thin metal layers, and thus the exposed layer does not require a cover coating to protect this layer from the environment. As described above, having a single exposed layer has many advantages over coatings that require protective cover coatings.

The exposed layer is optically transparent. Even though the layer is comprised of graphite particles, because the layer is very thin, it has these desirable optical properties. Typically, the exposed layer has a visible light transmission (% T) of at least 75%. In some embodiments, the % T can be 80% or higher.

As mentioned above, it is desirable that the exposed layer be thin. Typically, the exposed layer has a thickness of from 0.34 nanometers to 3 micrometers. In some embodiments the thickness is 1.0 nanometers to 1.0 micrometers, 5 nanometers to 1.0 micrometers, or even 10 nanometers to 1.0 micrometers.

Another extremely important property is the surface resistivity of the exposed layer. As mentioned above, the surface resistivity of the exposed layer is less than 1×10⁵ Ohms/square.

The conductive film is designed to cover a portion of the adhesive layer of the cover tape construction, to prevent the adhesive layer from being exposed in the regions where the conductive film covers the adhesive layer. In this way an electronic component contained within the indented segment of the carrier tape is protected from exposure to the adhesive layer. One way that the adhesive layer could contact the electronic component contained within the indented segment of the carrier tape is if the adhesive can ooze through the conductive film. This can happen if the conductive film becomes abraded during the processing or use of the cover tape construction. This abrasion can take many forms, such as cracking, slitting, or puncturing. The conductive film having an exposed conductive layer of the present disclosure is abrasion-resistant. This abrasion resistance is important in order for the cover tape construction to be able to withstand the processing conditions to which it is subjected. Abrasion resistance in this context is somewhat different from the properties often associated with this term. Often the term is used to describe, for example, hard coats, where abrasion resistance is characterized by the resistance to scratching upon rubbing with a cloth or an abrasive substrate. While these exposed coatings can be wiped with a cloth or similar cleaning wipe without being degraded, as used herein, the term “abrasion-resistant” refers to a property of the cover tape construction, in which the conductive film, when abraded by slitting, resists the oozing of adhesive through the slit. This property is modeled by a series of abrasion simulation tests that are described in greater detail in the Examples section, but in essence the test is to determine whether adhesive from the adhesive layer oozes when the conductive film is slit. In other words, the conductive film is slit by a sharp blade and the extent of adhesive ooze is observed over time and under a variety of conditions of temperature and applied weight. As mentioned above, adhesive ooze is a very serious concern, because if the adhesive oozes through the conductive film of the cover tape construction, the adhesive can contact the electronic component contained in the indented segments of the carrier tape. If the adhesive contacts the electronic component, a variety of detrimental things can result. In some instances the electronic component can be damaged or ruined by adhesive contact. In other instances the electronic component can become affixed to the cover tape construction and thus not be deliverable from the carrier tape. The conductive films of the present disclosure display no adhesive ooze when tested as described in the Examples section.

In addition to the specialized abrasion resistance described above, the abrasion-resistant, electrically conductive coatings also are scratch resistant. Scratch resistance, as the term implies, refers to the ability of the coating to resist scratching and is modeled using the test method described in the Examples section.

Also, as mentioned above, it is desirable that the abrasion-resistant, electrically conductive coatings have a low surface energy. This low surface energy helps to prevent adhesion between the cover tape and the electronic component contained within the indented segment of the carrier tape, if the cover tape surface encounters the electronic component surface. Again, as with the adhesive ooze problem that was described above, adhesion between the electronic component and the cover tape is extremely undesirable. Additionally, in embodiments where the cover tape is to be supplied in roll form and thus the exposed conductive coating can come in contact with the low adhesion backsize coating of the cover tape construction, the low surface energy of the abrasion-resistant, electrically conductive coatings prevents sticking and permits easy unrolling of the tape.

In some embodiments, the exposed layer of abrasion-resistant, electrically conductive graphite nano-scale particles has a surface energy of between 25.0 and 30.0 milliNewtons/meter as measured by a water contact angle test.

In addition to the above listed properties, the cover tape constructions of this disclosure are also sufficiently flexible to be rolled upon itself so that the tape construction can be supplied and used in the form of a roll.

The layer of abrasion-resistant, electrically conductive graphite nano-scale particles is prepared by a buff coating process such as is described in U.S. Pat. No. 6,511,701 (Divigalpitiya et al.). In this process, a mixture of dry particles are applied to the first major surface of the second polymeric substrate and buffed into the surface of the substrate at a pressure of less than 30 grams per centimeter with an applicator that moves in a manner parallel to the surface of the substrate.

The mixture of particles comprises graphite particles, where the graphite particles have a Mohs hardness of from 0.5-2.0 and the largest dimension of the particle is less than 100 micrometers. Graphite particles are exfoliatable particles, meaning that the particles break up into flakes, scales, sheets or layers upon application of a shear force. Thus, during the buff coating process the graphite particles exfoliate.

The mixture of particles may also include at least one type of buffing aid particle. Buffing aid particles have a low affinity for the substrate and also have a low affinity for the graphite particles. A particle is considered to have a low affinity for a substrate if the particles will not stay on the substrate by itself if buffed on the substrate using the methods of the present disclosure. Such buffing aid particles tend to separate from the exfoliatable particles during the buffing process, and help the distribution and uniformity of the exfoliatable particles on the substrate. Little or no buffing aid particles remain on the final coated product. Examples of such buffing aid particles include RADIANT MP series of encapsulated dye particles from Radiant Color Co. (Richmond, Calif.), such as magenta, MP orange, MP chartreuse, and clear particles. Other buffing aid particles include Methyl red dye particles having a CAS number of 493-52-7, Methylene blue dye particles having a CAS number of 75-09-2, Perylene Red pigment, Rhodamine B dye having a CAS number of 81-88-9, Malachite green oxalate having a CAS number of 2437-29-8, and Azure A dye having a CAS number of 531-53-3.

In the process of the present disclosure, the buffing pad is moved in the plane of the substrate parallel to the substrate surface. The orbital motion of the pad in the present disclosure is carried out with its rotational axis perpendicular to the substrate or web. Thus, the pad moves in a plurality of directions during the buffing application, including directions transverse to the direction of the web in the case where the web is moving past the buffing pad.

Applicator pads that are suitable may be any appropriate material for applying particles to a surface. For example, the applicator pad may be a woven or non-woven fabric or cellulosic material. Alternatively, the pad may be a closed cell or open cell foam material. In yet another alternative, the pad may be a brush or an array of bristles. Generally, the bristles of such a brush have a length of about 0.2-1 cm, and a diameter of about 30-100 micrometers. Bristles are generally made from nylon or polyurethane. Particularly suitable buffing applicators include foam pads, EZ PAINTR pads (described in U.S. Pat. No. 3,369,268), lamb's wool pads, 3M “PERFECT IT” pads, and the like.

The buffing applicator moves in an orbital pattern parallel to the surface of the substrate with its rotational axis perpendicular to the plane of the substrate. The buffing motion can be a simple orbital motion or a random orbital motion. The typical orbital motion used is in the range of 1,000-10,000 orbits per minute.

As is taught in U.S. Pat. No. 6,511,701 (Divigalpitiya et al.), the coatings typically adhere well after aging. In some embodiments, it may be desirable to heat the substrate after the buffing operation to improve the adhesion of the coating, but typically, the graphite coatings of the present disclosure do not require heating and typically have excellent adhesion to the substrate after one day of aging at room temperature. Optionally, if desired, the excess loose powder that does not adhere to the surface of the substrate can be removed from the surface coated article by conventional techniques such as blowing with a stream of air or other gas or through the use of a vacuum cleaner.

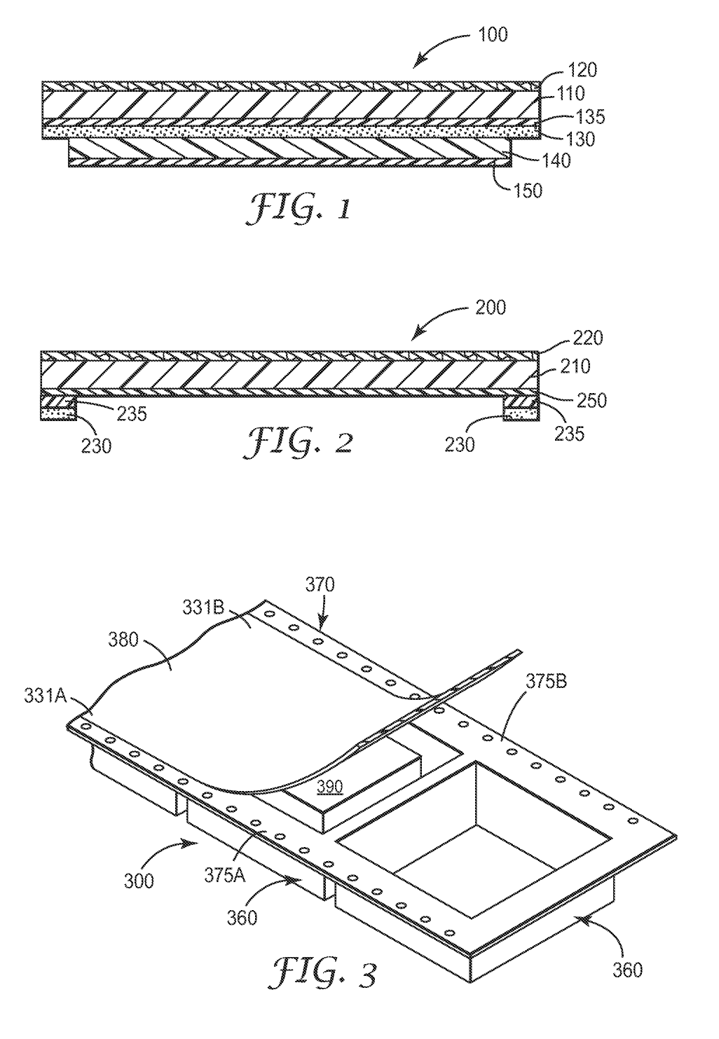

An embodiment of the first type of multi-layer cover tape construction is shown in FIG. 1. FIG. 1 is a cross sectional view of cover tape 100, which includes first polymeric substrate 110, low adhesion backsize coating 120, adhesive layer 130 and optional primer layer 135, second polymeric substrate 140 and abrasion-resistant, electrically conductive graphite coating 150.

The second type of multi-layer cover tape construction comprises a first polymeric substrate with a first major surface and a second major surface, a low adhesion backsize coating layer on the second major surface of the first polymeric substrate, an electrically conductive coating on the first major surface of the first polymeric substrate, and stripes of adhesive on a portion of the electrically conductive coating on the first major surface of the first polymeric substrate such that portions of the electrically conductive coating remain exposed between the adhesive stripes. The conductive layer comprises an exposed layer of abrasion-resistant, electrically conductive nano-scale graphite particles coated on the first major surface of the first polymeric substrate, where the exposed layer of abrasion-resistant, electrically conductive nano-scale graphite particles is an optically transparent layer and has a surface resistance of less than 1×10⁵ Ohms/square, and the exposed layer of abrasion-resistant, electrically conductive nano-scale graphite particles coated on the first major surface of the first polymeric substrate is coated by buff coating.

Many of the elements of this second type of multi-layer cover tape construction are the same or can be the same as those described above. Thus the first polymeric substrate, adhesive, low adhesion backsize, and electrically conductive coating are as described above. Additionally, as described above, the multi-layer cover tape construction can also include an optional primer layer between the surface of the polymeric substrate and the adhesive stripes.

An embodiment of the second type of multi-layer cover tape construction is shown in FIG. 2. FIG. 2 is a cross sectional view of cover tape 200, which includes first polymeric substrate 210, low adhesion backsize coating 220, adhesive stripes 230, optional primer layer 235, and abrasion resistant electrically conductive graphite coating 250.

Also disclosed herein are carrier tape assemblies that incorporate the cover tape constructions described above. The carrier tape assembly comprises a carrier tape for electronic component transportation, the carrier tape comprising parallel strip portions in a lengthwise direction, the strip portions having top and bottom surfaces, and between the parallel strip portions, a plurality of indented segments for accommodating electronic components formed intermittently in the lengthwise direction of the tape, and a cover tape construction for releasably sealing the indented portions of the carrier tape, the cover tape construction comprising one of the cover tape constructions described above.

In some embodiments, the cover tape construction comprises a first polymeric substrate with a first major surface and a second major surface, an adhesive layer coated on the first major surface of the first polymeric substrate, a low adhesion backsize coating layer on the second major surface of the first polymeric substrate and a conductive film construction adhered to a portion of the adhesive layer such that portions of the adhesive remain exposed. The conductive film construction comprises a second polymeric substrate with a first major surface and a second major surface, where the second major surface of the second polymeric substrate is adhered to the adhesive layer, and an exposed layer of abrasion-resistant, electrically conductive nano-scale graphite particles is coated on the first major surface of the second polymeric substrate. The exposed layer of abrasion-resistant, electrically conductive nano-scale graphite particles is an optically transparent layer and has a surface resistance of less than 1×10⁵ Ohms/square. The exposed layer of abrasion-resistant, electrically conductive nano-scale graphite particles coated on the first major surface of the second polymeric substrate are coated by buff coating.

In other embodiments, the cover tape construction comprises a first polymeric substrate with a first major surface and a second major surface, a low adhesion backsize coating layer on the second major surface of the first polymeric substrate, an electrically conductive coating on the first major surface of the first polymeric substrate, and stripes of adhesive on a portion of the electrically conductive coating on the first major surface of the first polymeric substrate such that portions of the electrically conductive coating remain exposed between the adhesive stripes. The conductive layer comprises an exposed layer of abrasion-resistant, electrically conductive nano-scale graphite particles coated on the first major surface of the first polymeric substrate, where the exposed layer of abrasion-resistant, electrically conductive nano-scale graphite particles is an optically transparent layer and has a surface resistance of less than 1×10⁵ Ohms/square, and the exposed layer of abrasion-resistant, electrically conductive nano-scale graphite particles coated on the first major surface of the first polymeric substrate is coated by buff coating.

An embodiment of a carrier tape assembly of this disclosure is shown in FIG. 3. FIG. 3 is a cross sectional view of carrier tape assembly 300 which includes indented portions 360 with adjacent strip portion 370 having edge portions 375A and 375B. Cover tape 380 includes adhesively bonded areas 331A and 331B that are bonded to longitudinal edge surfaces 375A and 375B of the strip portion 370. The indented portions 360 contain components 390.

Also disclosed herein are methods of forming multi-layer cover tape constructions. In some embodiments, the method comprises providing an adhesive tape construction comprising a first polymeric substrate with a first major surface and second major surface with a low adhesion backsize coating on the second major surface of the first polymeric substrate, and an adhesive layer coated on the first major surface of the first polymeric substrate, forming an electrically conductive film construction, and adhering the second major surface of the second polymeric substrate to the adhesive layer such that portions of the adhesive layer remain exposed on either side of the second polymeric substrate. Providing the electrically conductive film construction comprises providing a second polymeric substrate with a first major surface and a second major surface, applying a dry particle composition comprising graphite particles to the first major surface of the second polymeric substrate, where the dry particle composition comprising graphite particles comprises particles having a large dimension of less than 100 micrometers, and comprising graphite and may optionally include at least one type of buffing aid particle, using an applicator pad and buffing an effective amount of the graphite particles onto the surface of the polymeric substrate at a pressure normal to the surface of greater than 0 and less than about 30 grams per centimeter, where the applicator pad moves in a plane parallel to the surface of the polymeric substrate in an orbital fashion. The buff coated graphite surface on the first major surface of the second polymeric substrate is optically transparent and has a surface resistance of less than 1×10⁵ Ohms/square.

In other embodiments, the method of forming a multi-layer cover tape construction comprises providing a first polymeric substrate with a first major surface and second major surface with a low adhesion backsize coating on the second major surface of the first polymeric substrate, and forming an electrically conductive coating on the first major surface of the first polymeric substrate, and applying adhesive stripes to a portion of the electrically conductive coating on the first major surface of the first polymeric substrate such that portions of the electrically conductive coating remain exposed between the adhesive stripes. Forming an electrically conductive coating comprises applying a dry particle composition comprising graphite particles to the first major surface of the first polymeric substrate, where the dry particle composition comprising graphite particles comprises particles having a large dimension of less than 100 micrometers, and comprising graphite and may optionally include at least one type of buffing aid particle, using an applicator pad and buffing an effective amount of the graphite particles onto the surface of the polymeric substrate at a pressure normal to the surface of greater than 0 and less than about 30 grams per centimeter, where the applicator pad moves in a plane parallel to the surface of the polymeric substrate in an orbital fashion. The buff coated electrically conductive graphite surface on the first major surface of the first polymeric substrate is optically transparent and has a surface resistance of less than 1×10⁵ Ohms/square.

In some embodiments, the method further comprises applying primer layer stripes to the electrically conductive coating prior to applying the adhesive stripes, such that the primer layer stripes form a continuous layer between the electrically conductive coating and the adhesive stripes.

This disclosure includes the following embodiments:

Among the embodiments are multi-layer cover tape constructions. A first embodiment includes a multi-layer cover tape construction comprising: a first polymeric substrate with a first major surface and a second major surface; an adhesive layer coated on the first major surface of the first polymeric substrate; a low adhesion backsize coating layer on the second major surface of the first polymeric substrate; and a conductive film construction adhered to a portion of the adhesive layer such that portions of the adhesive remain exposed, the conductive film construction comprising: a second polymeric substrate with a first major surface and a second major surface, wherein the second major surface of the second polymeric substrate is adhered to the adhesive layer; and an exposed layer of abrasion-resistant, electrically conductive nano-scale graphite particles coated on the first major surface of the second polymeric substrate, wherein the exposed layer of abrasion-resistant, electrically conductive nano-scale graphite particles is an optically transparent layer and has a surface resistance of less than 1×10⁵ Ohms/square, and wherein the exposed layer of abrasion-resistant, electrically conductive nano-scale graphite particles coated on the first major surface of the second polymeric substrate are coated by buff coating.

Embodiment 2 is the cover tape of embodiment 1, wherein the exposed layer of abrasion-resistant, electrically conductive nano-scale graphite particles has a thickness of from 0.34 nanometers to 3 micrometers.

Embodiment 3 is the cover tape of embodiment 1, wherein the exposed layer of abrasion-resistant, electrically conductive nano-scale graphite particles has a thickness of from 1.0 nanometers to 1.0 micrometers.

Embodiment 4 is the cover tape of embodiment 1, wherein the exposed layer of abrasion-resistant, electrically conductive nano-scale graphite particles has a thickness of from 5 nanometers to 1.0 micrometers.

Embodiment 5 is the cover tape of embodiment 1, wherein the exposed layer of abrasion-resistant, electrically conductive nano-scale graphite particles has a thickness of from 10 nanometers to 1.0 micrometers.

Embodiment 6 is the cover tape of any of embodiments 1-5, wherein the nano-scale graphite particles have a Mohs hardness of from 0.5-2.0.

Embodiment 7 is the cover tape of any of embodiments 1-6, wherein the exposed layer of abrasion-resistant, electrically conductive nano-scale graphite particles comprises a scratch resistant coating.

Embodiment 8 is the cover tape of any of embodiments 1-7, further comprising a primer layer between the first polymeric substrate and the adhesive layer.

Embodiment 9 is the cover tape of any of embodiments 1-8, wherein the adhesive comprises a pressure sensitive adhesive.

Embodiment 10 is the cover tape of any of embodiments 1-8, wherein the adhesive comprises a heat activated adhesive.

Embodiment 11 is the cover tape of any of embodiments 1-10, wherein the exposed layer of abrasion-resistant, electrically conductive graphite nano-scale particles has a surface energy of between 25.0 and 30.0 milliNewtons/meter as measured by a water contact angle test.

Embodiment 12 is the cover tape of any of embodiments 1-11, wherein the tape comprises a roll of tape with the exposed layer of abrasion-resistant, electrically conductive graphite nano-scale particles in contact with the low adhesion backsize coating layer.

Embodiment 13 is the cover tape of any of embodiments 1-12, wherein the first and second polymeric substrates independently comprise films of polyester, polyolefin, polyurethane, polyacrylate, polyvinyl, polymethylmethacrylate, polycarbonate, or combinations thereof.

Embodiment 14 includes a multi-layer cover tape construction comprising: a first polymeric substrate with a first major surface and a second major surface; a low adhesion backsize coating layer on the second major surface of the first polymeric substrate; and an electrically conductive coating on the first major surface of the first polymeric substrate, the conductive layer comprising: an exposed layer of abrasion-resistant, electrically conductive nano-scale graphite particles coated on the first major surface of the first polymeric substrate, wherein the exposed layer of abrasion-resistant, electrically conductive nano-scale graphite particles is an optically transparent layer and has a surface resistance of less than 1×10⁵ Ohms/square, and wherein the exposed layer of abrasion-resistant, electrically conductive nano-scale graphite particles coated on the first major surface of the second polymeric substrate are coated by buff coating; and stripes of adhesive on a portion of the electrically conductive coating on the first major surface of the first polymeric substrate such that portions of the electrically conductive coating remain exposed between the adhesive stripes.

Embodiment 15 is the cover tape of embodiment 14, wherein the exposed layer of abrasion-resistant, electrically conductive nano-scale graphite particles has a thickness of from 0.34 nanometers to 3 micrometers.

Embodiment 16 is the cover tape of embodiment 14, wherein the exposed layer of abrasion-resistant, electrically conductive nano-scale graphite particles has a thickness of from 1.0 nanometers to 1.0 micrometers.

Embodiment 17 is the cover tape of embodiment 14, wherein the exposed layer of abrasion-resistant, electrically conductive nano-scale graphite particles has a thickness of from 5 nanometers to 1.0 micrometers.

Embodiment 18 is the cover tape of embodiment 14, wherein the exposed layer of abrasion-resistant, electrically conductive nano-scale graphite particles has a thickness of from 10 nanometers to 1.0 micrometers.

Embodiment 19 is the cover tape of any of embodiments 14-18, wherein the nano-scale graphite particles have a Mohs hardness of from 0.5-2.0.

Embodiment 20 is the cover tape of any of embodiments 14-19, wherein the exposed layer of abrasion-resistant, electrically conductive nano-scale graphite particles comprises a scratch resistant coating.

Embodiment 21 is the cover tape of any of embodiments 14-20, further comprising a primer layer between the first polymeric substrate and the adhesive stripes.

Embodiment 22 is the cover tape of any of embodiments 14-21, wherein the adhesive comprises a pressure sensitive adhesive.

Embodiment 23 is the cover tape of any of embodiments 14-21, wherein the adhesive comprises a heat activated adhesive.

Embodiment 24 is the cover tape of any of embodiments 14-23, wherein the exposed layer of abrasion-resistant, electrically conductive graphite nano-scale particles has a surface energy of between 25.0 and 30.0 milliNewtons/meter as measured by a water contact angle test.

Embodiment 25 is the cover tape of any of embodiments 14-24, wherein the tape comprises a roll of tape with the exposed layer of abrasion-resistant, electrically conductive graphite nano-scale particles in contact with the low adhesion backsize coating layer.

Embodiment 26 is the cover tape of any of embodiments 14-25, wherein the first and second polymeric substrates independently comprise films of polyester, polyolefin, polyurethane, polyacrylate, polyvinyl, polymethylmethacrylate, polycarbonate, or combinations thereof.

Also disclosed are embodiments of carrier tape assemblies. Embodiment 27 includes a carrier tape assembly comprising: a carrier tape for electronic component transportation, the carrier tape comprising: parallel strip portions in a lengthwise direction, the strip portions having top and bottom surfaces, and between the parallel strip portions, a plurality of indented segments for accommodating electronic components formed intermittently in the lengthwise direction of the tape; and a cover tape construction for releasably sealing the indented portions of the carrier tape, the cover tape construction comprising: a first polymeric substrate with a first major surface and a second major surface; an adhesive layer coated on the first major surface of the first polymeric substrate; a low adhesion backsize coating layer on the second major surface of the first polymeric substrate; and a conductive film construction adhered to a portion of the adhesive layer such that portions of the adhesive remain exposed, the conductive film construction comprising: a second polymeric substrate with a first major surface and a second major surface, wherein the second major surface of the second polymeric substrate is adhered to the adhesive layer; and an exposed layer of abrasion-resistant, electrically conductive nano-scale graphite particles coated on the first major surface of the second polymeric substrate, wherein the exposed layer of abrasion-resistant, electrically conductive nano-scale graphite particles is an optically transparent layer and has a surface resistance of less than 1×10⁵ Ohms/square, wherein the exposed adhesive portions are releasably adhesively bonded to the top surface of the parallel strip portions of the carrier tape.

Embodiment 28 is the carrier tape of embodiment 27, wherein the exposed layer of abrasion-resistant, electrically conductive nano-scale graphite particles has a thickness of from 0.34 nanometers to 3 micrometers.

Embodiment 29 is the carrier tape of embodiment 27, wherein the exposed layer of abrasion-resistant, electrically conductive nano-scale graphite particles has a thickness of from 1.0 nanometers to 1.0 micrometers.

Embodiment 30 is the carrier tape of embodiment 27, wherein the exposed layer of abrasion-resistant, electrically conductive nano-scale graphite particles has a thickness of from 5 nanometers to 1.0 micrometers.

Embodiment 31 is the carrier tape of embodiment 27, wherein the exposed layer of abrasion-resistant, electrically conductive nano-scale graphite particles has a thickness of from 10 nanometers to 1.0 micrometers.

Embodiment 32 is the carrier tape of any of embodiments 27-31, wherein the nano-scale graphite particles have a Mohs hardness of from 0.5-2.0.

Embodiment 33 is the carrier tape of any of embodiments 27-32, wherein the exposed layer of abrasion-resistant, electrically conductive nano-scale graphite particles comprises a scratch resistant coating.

Embodiment 34 is the carrier tape of any of embodiments 27-33, further comprising a primer layer between the first polymeric substrate and the adhesive layer.

Embodiment 35 is the carrier tape of any of embodiments 27-34, wherein the adhesive comprises a pressure sensitive adhesive.

Embodiment 36 is the carrier tape of any of embodiments 27-34, wherein the adhesive comprises a heat activated adhesive.

Embodiment 37 is the carrier tape of any of embodiments 27-36, wherein the exposed layer of abrasion-resistant, electrically conductive graphite nano-scale particles has a surface energy of between 25.0 and 30.0 milliNewtons/meter as measured by a water contact angle test.

Embodiment 38 is the carrier tape of any of embodiments 27-37, wherein the tape comprises a roll of tape with the exposed layer of abrasion-resistant, electrically conductive graphite nano-scale particles in contact with the low adhesion backsize coating layer.

Embodiment 39 is the carrier tape of any of embodiments 27-38, wherein the first and second polymeric substrates independently comprise films of polyester, polyolefin, polyurethane, polyacrylate, polyvinyl, polymethylmethacrylate, polycarbonate, or combinations thereof.

Embodiment 40 includes a carrier tape assembly comprising: a carrier tape for electronic component transportation, the carrier tape comprising: parallel strip portions in a lengthwise direction, the strip portions having top and bottom surfaces, and between the parallel strip portions, a plurality of indented segments for accommodating electronic components formed intermittently in the lengthwise direction of the tape; and a cover tape construction for releasably sealing the indented portions of the carrier tape, the cover tape construction comprising: a first polymeric substrate with a first major surface and a second major surface; a low adhesion backsize coating layer on the second major surface of the first polymeric substrate; and an electrically conductive coating on the first major surface of the first polymeric substrate, the conductive layer comprising: an exposed layer of abrasion-resistant, electrically conductive nano-scale graphite particles coated on the first major surface of the first polymeric substrate, wherein the exposed layer of abrasion-resistant, electrically conductive nano-scale graphite particles is an optically transparent layer and has a surface resistance of less than 1×10⁵ Ohms/square, and wherein the exposed layer of abrasion-resistant, electrically conductive nano-scale graphite particles coated on the first major surface of the second polymeric substrate are coated by buff coating; and stripes of adhesive on a portion of the electrically conductive coating on the first major surface of the first polymeric substrate such that portions of the electrically conductive coating remain exposed between the adhesive stripes, and wherein the exposed adhesive stripes are releasably adhesively bonded to the top surface of the parallel strip portions of the carrier tape.

Embodiment 41 is the carrier tape of embodiment 40, wherein the exposed layer of abrasion-resistant, electrically conductive nano-scale graphite particles has a thickness of from 0.34 nanometers to 3 micrometers.

Embodiment 42 is the carrier tape of embodiment 40, wherein the exposed layer of abrasion-resistant, electrically conductive nano-scale graphite particles has a thickness of from 1.0 nanometers to 1.0 micrometers.

Embodiment 43 is the carrier tape of embodiment 40, wherein the exposed layer of abrasion-resistant, electrically conductive nano-scale graphite particles has a thickness of from 5 nanometers to 1.0 micrometers.

Embodiment 44 is the carrier tape of embodiment 40, wherein the exposed layer of abrasion-resistant, electrically conductive nano-scale graphite particles has a thickness of from 10 nanometers to 1.0 micrometers.

Embodiment 45 is the carrier tape of any of embodiments 40-44, wherein the nano-scale graphite particles have a Mohs hardness of from 0.5-2.0.

Embodiment 46 is the carrier tape of any of embodiments 40-45, wherein the exposed layer of abrasion-resistant, electrically conductive nano-scale graphite particles comprises a scratch resistant coating.

Embodiment 47 is the carrier tape of any of embodiments 40-46, further comprising a primer layer between the first polymeric substrate and the adhesive stripes. Embodiment 48 is the carrier tape of any of embodiments 40-47, wherein the adhesive comprises a pressure sensitive adhesive.

Embodiment 49 is the carrier tape of any of embodiments 40-47, wherein the adhesive comprises a heat activated adhesive.

Embodiment 50 is the carrier tape of any of embodiments 40-49, wherein the exposed layer of abrasion-resistant, electrically conductive graphite nano-scale particles has a surface energy of between 25.0 and 30.0 milliNewtons/meter as measured by a water contact angle test.

Embodiment 51 is the carrier tape of any of embodiments 40-50, wherein the tape comprises a roll of tape with the exposed layer of abrasion-resistant, electrically conductive graphite nano-scale particles in contact with the low adhesion backsize coating layer.

Embodiment 52 is the carrier tape of any of embodiments 40-51, wherein the first and second polymeric substrates independently comprise films of polyester, polyolefin, polyurethane, polyacrylate, polyvinyl, polymethylmethacrylate, polycarbonate, or combinations thereof.

Also disclosed are methods of forming multi-layer cover tape constructions. Embodiment 53 includes a method of forming a multi-layer cover tape construction comprising: providing an adhesive tape construction comprising: a first polymeric substrate with a first major surface and second major surface; a low adhesion backsize coating on the second major surface of the first polymeric substrate; and an adhesive layer coated on the first major surface of the first polymeric substrate; forming an electrically conductive film construction comprising: providing a second polymeric substrate with a first major surface and a second major surface; applying a dry particle composition comprising graphite particles to the first major surface of the second polymeric substrate, wherein the dry particle composition comprising graphite particles comprises particles having a largest dimension of less than 100 micrometers, and comprising graphite, and using an applicator pad and buffing an effective amount of the graphite particles onto the surface of the polymeric substrate at a pressure normal to the surface of greater than 0 and less than about 30 grams per centimeter, wherein the applicator pad moves in plane parallel to the surface of the polymeric substrate in an orbital fashion; and adhering the second major surface of the second polymeric substrate to the adhesive layer such that portions of the adhesive layer remain exposed on either side of the second polymeric substrate, wherein the buff coated graphite surface on the first major surface of the second polymeric substrate is optically transparent and has a surface resistance of less than 1×10⁵ Ohms/square.

Embodiment 54 is the method of embodiment 53, wherein the dry particle composition further comprises at least one buffing aid particle.

Embodiment 55 includes a method of forming a multi-layer cover tape construction comprising: providing a first polymeric substrate with a first major surface and second major surface with a low adhesion backsize coating on the second major surface of the first polymeric substrate; and forming an electrically conductive coating on the first major surface of the first polymeric substrate, wherein forming an electrically conductive coating comprises: applying a dry particle composition comprising graphite particles to the first major surface of the first polymeric substrate, wherein the dry particle composition comprising graphite particles comprises particles having a largest dimension of less than 100 micrometers, and comprising graphite, and using an applicator pad and buffing an effective amount of the graphite particles onto the surface of the polymeric substrate at a pressure normal to the surface of greater than 0 and less than about 30 grams per centimeter, wherein the applicator pad moves in plane parallel to the surface of the polymeric substrate in an orbital fashion; and applying adhesive stripes to a portion of the electrically conductive coating on the first major surface of the first polymeric substrate such that portions of the electrically conductive coating remain exposed between the adhesive stripes; and wherein the buff coated electrically conductive graphite surface on the first major surface of the first polymeric substrate is optically transparent and has a surface resistance of less than 1×10⁵ Ohms/square.

Embodiment 56 is the method of embodiment 55, wherein applying adhesive stripes to a portion of the electrically conductive coating on the first major surface of the first polymeric substrate, further comprises applying a primer layer stripes to the electrically conductive coating prior to applying the adhesive stripes, such that the primer layer stripes form continuous layer between the electrically conductive coating and the adhesive stripes.

Embodiment 57 is the method of embodiment 55 or 56, wherein the dry particle composition further comprises at least one buffing aid particle.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wis. unless otherwise noted. The following abbreviations are used: nm=nanometers; mm=millimeters; mN/m=milliNewtons/meter; RH=Relative Humidity; RT=room temperature. The terms “weight %”, “% by weight”, and “wt %” are used interchangeably.

Table of Abbreviations

| Abbreviation | |
|---|---|
| or Trade | |
| Designation | Description |
| PET Film-1 | A 12.5 micrometer (0.5 mil) thick film of polyethylene |
| | terephthalate commercially available as 2240N from |
| | Mistubishi Hostaphan |
| Graphite | Graphite powder commercially available as HSAG300 |
| powder | from TIMCAL Grahite and Carbon, Switzerland |
| PET Film-2 | A 25 micrometer (1.0 mil) thick film of polyethylene |
| | terephthalate commercially available from Mistubishi |
| | Hostaphan |
| LAB-1 | A polyurethane low adhesion backsize. |
| PSA-1 | An acrylate-based pressure sensitive adhesive. |
| Primer-1 | An acrylate-based primer. |
| Cover Tape-1 | Cover tape commercially available from Sumitomo |
| | Bakelite as “SUMILITE CSL-Z7302” |
| Cover Tape-2 | Cover Tape commercially available from 3M Company |
| | as “3M Static Dissipative Heat Activated Cover Tape 2675” |
| Cover Tape-3 | Cover Tape commercially available from 3M Company as |
| | “3M Static Dissipative Heat Activated Cover Tape 2678” |
| Cover Layer-1 | An acrylate-based transparent cover coating layer. |

### Test Methods

### Surface Energy (Contact Angle)

Surface energy was measured with an ATTENSION Contact Angle Analyzer/GONIOMETER. The instrument measured the contact angles using water and/or hexadecane and calculated the surface energy. Surface Energy values are reported in milliNewtons/meter.

### Abrasion Resistance

A series of three tests were carried out to samples of cover tape. In each test, the samples were inspected for adhesive squeeze out/oozing through a deliberately made slit or series of slits. The sample is said to “Pass” if no adhesive squeeze out/oozing is observed, and to “Fail” is adhesive squeeze out/oozing is observed.

Test 1: Samples of cover tape were slit through with a sharp blade. Adhesive squeeze out/oozing was inspected for after: 24 hours at RT (20° C., 70% RH); and 24 hours at 60° C.

Test 2: Samples of cover tape were slit through with a sharp blade. Adhesive squeeze out/oozing was inspected for after: 24 hours at RT (20° C., 70% RH) with a 1 kilogram hanging weight attached to the tape sample.

Test 3: Samples of cover tape were slit through at multiple places and the tape was run through a lamination roller. Adhesive squeeze out/oozing was inspected for.

### Scratch Resistance

Scratch resistance was measured with a scratch tester. Each sample surface was scratched 2 times with a scratch tip under a total load of 150 grams. The surface was then inspected under a microscope to observe if scratching had occurred.

### Visible Light Transmittance

The % transmittance of films according to the examples and comparative examples described below was determined in a wavelength range from 350 nm to 600 nm using a Filmetrics UV20 (San Diego, Calif.) thin film analyzer.

### Surface Resistivity

Surface resistance was measured with a Mitsubishi Hiresta HT-450 Meter. The surface resistivity was measured initially and after aging for up to 30 days under various temperature and humidity conditions.

### Examples 1-8

### Part 1

### Preparation of Graphite Coated Film

A nano-scale coating of graphite was made following the procedure described in U.S. Pat. No. 8,178,241 (Divigalpitiya et al.) except that PET Film-1 was used in place of a 12.5 micrometer thick Al foil. A sample of PET Film-1 was placed on a clean glass plate which was kept on a sample holder with holes around the glass plate. A shop-vacuum was connected to the holes to hold the PET Film-1 in place. Graphite Powder was dispensed on the film, and using a hand held Random Orbital Sander fitted with a paint pad (as described in U.S. Pat. No. 6,511,701), the powder was buffed on the foil by moving the sander back and forth with steady motion for different durations ranging from 8 to 30 seconds. Ionized air was used to blow off the excess powder around the plate and the vacuum was disconnected before removing the film. Visible light transmittance was measured using the test method described above and was 77%.

### Part 2

### Preparation of Adhesive Coated Tape

A sample of adhesive coated tape was prepared using PET Film-2, which was coated with LAB-1 on one side, and Primer-1 followed by a 12 micrometer (0.5 mil) thick coating of PSA-1 on the opposite side of the film.

### Part 3

### Preparation of Cover Tape

Cover tape samples of various widths were prepared by laminating together strips of the adhesive coated tape described above to the non-graphite coated side of the graphite coated film described above to form a cover tape as shown in FIG. 1. The graphite coated film was laminated to the center of the adhesive coated tape such that uncovered segments of the adhesive layer of the adhesive coated tape of equal width were present on either side of the graphite coated film as shown in FIG. 1. The dimensions of each component are described in Table 1 below.

TABLE 1

| | Width of Adhesive | Width of Graphite | Uncovered |
|---|---|---|---|
| | Coated Tape | Coated Film | Adhesive Segments |
| Example | (mm) | (mm) | (mm) |
| 1 | 5.3 | 3.96 | 0.67 |
| 2 | 5.4 | 3.4 | 1.0 |
| 3 | 9.3 | 7.3 | 1.0 |
| 4 | 9.3 | 6.7 | 1.3 |
| 5 | 13.3 | 11.3 | 1.0 |
| 6 | 13.3 | 10.7 | 1.3 |
| 7 | 21.3 | 19.3 | 1.0 |
| 8 | 21.3 | 18.7 | 1.3 |

### Part 4

### Testing of Cover Tapes

A sample of the cover tape of Example 1 was tested using the test methods described above. Testing for Comparative Examples C1-C3 were run using Cover Tapes 1-3, Comparative Examples C4A-D were prepared as described below. The data are presented in Tables 2-5 below.

TABLE 2
Surface Energy

| | | Contact Angle | Contact Angle | Surface |
|---|---|---|---|---|
| | | Water | Hexadecane | Energy |
| Example | Tape Sample | (°) | (°) | (mN/m) |
| 1 | Example 1 | 63.8 | NM | 27.5 |
| C1 | Cover Tape-1 | 88.7 | NM | 27.5 |
| C2 | Cover Tape-2 | 54.7 | 24.6 | 54.6 |
| C3 | Cover Tape-3 | 63.2 | 30.1 | 54.3 |
| C4A | Comparative | 77.9 | 17.9 | 51.1 |
| | Cover Tape | | | |

NM = Not measured, unable to obtain a value

TABLE 3
Scratch Testing

| Example | Scratch Testing Results |
|---|---|
| 1 | No Scratches Observed |
| C4A | Noticeable Scratches Observed |

TABLE 4
Surface Resistivity of Example 1 (all values are in Ohms/square)

| Time of | Room | 52° C./95% | 40° C./90% | | |
|---|---|---|---|---|---|
| Aging | Temperature | RH | RH | 60° C. | −20° C. |
| Initial | 3.33 × 10⁴ | 3.33 × 10⁴ | 3.33 × 10⁴ | 3.33 × 10⁴ | 3.33 × 10⁴ |
| Aged 3 Days | 3.92 × 10⁴ | 3.73 × 10⁴ | 4.91 × 10⁴ | 4.04 × 10⁴ | 4.28 × 10⁴ |
| Aged 7 Days | 4.24 × 10⁴ | 4.41 × 10⁴ | 4.94 × 10⁴ | 4.41 × 10⁴ | 4.30 × 10⁴ |
| Aged 10 Days | 4.69 × 10⁴ | 4.93 × 10⁴ | 4.68 × 10⁴ | 5.02 × 10⁴ | 4.33 × 10⁴ |
| Aged 20 Days | 4.86 × 10⁴ | 5.64 × 10⁴ | 7.37 × 10⁴ | 5.05 × 10⁴ | 4.87 × 10⁴ |
| Aged 30 Days | 4.98 × 10⁴ | 5.44 × 10⁴ | 6.68 × 10⁴ | 5.98 × 10⁴ | 4.80 × 10⁴ |

TABLE 5
Abrasion Resistance

| | Test 1 | Test 1 | | |
|---|---|---|---|---|
| Example | (24 hr RT) | (24 hr 60° C.) | Test 2 | Test 3 |
| 1 | Pass | Pass | Pass | Pass |

### Comparative Examples C4A-D

### Cover Tape with Covered Metal Conductive Layer

Part 1: Preparation of Film with a Coated Metal Conductive Layer

A coated metal conductive film was prepared by sputter coating of a conductive layer of nickel and chromium onto a sample of PET Film-1. This metal layer was coated with Cover Layer-1. Visible light transmittance was measured using the test method described above and was 85%.

### Part 2: Preparation of Adhesive Coated Tape

A sample of adhesive coated tape was prepared using PET Film-2, which was coated with LAB-1 on one side, and Primer-1 followed by a 12 micrometer (0.5 mil) thick coating of PSA-1 on the opposite side of the film.

### Part 3: Preparation of Cover Tape:

Cover tape samples of various widths were prepared by laminating together strips of the adhesive coated tape described above to the non-metal coated side of the coated metal conductive film described above to form a cover tape similar to the cover tapes described above. The coated metal conductive film was laminated to the center of the adhesive coated tape such that uncovered segments of the adhesive layer of the adhesive coated tape of equal width were present on either side of the coated metal conductive film as shown in FIG. 1. The dimensions of each component are described in Table 6 below.

TABLE 6

| | Width of Adhesive | Width of Coated | Uncovered |
|---|---|---|---|
| | Coated Tape | Metal Film | Adhesive Segments |
| Example | (mm) | (mm) | (mm) |
| C4A | 5.3 | 3.96 | 0.67 |
| C4B | 9.3 | 7.3 | 1.0 |
| C4C | 13.3 | 11.3 | 1.0 |
| C4D | 21.3 | 19.3 | 1.0 |

What is claimed is:

1. A multi-layer cover tape construction comprising:
a first polymeric substrate with a first major surface and a second major surface;
an adhesive layer coated on the first major surface of the first polymeric substrate;
a low adhesion backsize coating layer on the second major surface of the first polymeric substrate; and
a conductive film construction adhered to a portion of the adhesive layer such that portions of the adhesive layer remain exposed, the conductive film construction comprising:
a second polymeric substrate with a first major surface and a second major surface, wherein the second major surface of the second polymeric substrate is adhered to the adhesive layer; and
an exposed layer of abrasion-resistant, electrically conductive nano-scale graphite particles coated on the first major surface of the second polymeric substrate, wherein the exposed layer of abrasion-resistant, electrically conductive nano-scale graphite particles is an optically transparent layer and
has a surface resistance of less than 1×10⁵ Ohms/square, and wherein the exposed layer of abrasion-resistant, electrically conductive nano-scale graphite particles coated on the first major surface of the second polymeric substrate is coated by buff coating.

2. The cover tape of claim 1, wherein the exposed layer of abrasion-resistant, electrically conductive nano-scale graphite particles has a thickness of from 0.34 nanometers to 3 micrometers.

3. The cover tape of claim 1, wherein the nano-scale graphite particles have a Mohs hardness of from 0.5-2.0.

4. The cover tape of claim 1, further comprising a primer layer between the first polymeric substrate and the adhesive layer.

5. The cover tape of claim 1, wherein the adhesive comprises a pressure sensitive adhesive.

6. The cover tape of claim 1, wherein the exposed layer of abrasion-resistant, electrically conductive graphite nano-scale particles has a surface energy of between 25.0 and 30.0 milliNewtons/meter as measured by a water contact angle test.

7. The cover tape of claim 1, wherein the tape comprises a roll of tape with the exposed layer of abrasion-resistant, electrically conductive graphite nano-scale particles in contact with the low adhesion backsize coating layer.

8. The cover tape of claim 1, wherein the first and second polymeric substrates independently comprise films of polyester, polyolefin, polyurethane, polyacrylate, polyvinyl, polymethylmethacrylate, polycarbonate, or combinations thereof.

9. A carrier tape assembly comprising;
a carrier tape for electronic component transportation, the carrier tape comprising: parallel strip portions in a lengthwise direction, the strip portions having top and bottom surfaces, and between the parallel strip portions, a plurality of indented segments for accommodating electronic components formed intermittently in the lengthwise direction of the tape; and
a cover tape construction for releasably sealing the indented portions of the carrier tape, the cover tape construction comprising:
a first polymeric substrate with a first major surface and a second major surface;
an adhesive layer coated on the first major surface of the first polymeric substrate;
a low adhesion backsize coating layer on the second major surface of the first polymeric substrate; and
a conductive film construction adhered to a portion of the adhesive layer such that portions of the adhesive layer remain exposed, the conductive film construction comprising:
a second polymeric substrate with a first major surface and a second major surface, wherein the second major surface of the second polymeric substrate is adhered to the adhesive layer; and
an exposed layer of abrasion-resistant, electrically conductive nano-scale graphite particles coated on the first major surface of the second polymeric substrate, wherein the exposed layer of abrasion-resistant, electrically conductive nano-scale graphite particles is an optically transparent layer and has a surface resistance of less than 1×10⁵ Ohms/square,
wherein the exposed adhesive portions are releasably adhesively bonded to the top surface of the parallel strip portions of the carrier tape.

10. A multi-layer cover tape construction comprising:
a first polymeric substrate with a first major surface and a second major surface;
a low adhesion backsize coating layer on the second major surface of the first polymeric substrate; and
an electrically conductive coating on the first major surface of the first polymeric substrate, the conductive layer comprising:
an exposed layer of abrasion-resistant, electrically conductive nano-scale graphite particles coated on the first major surface of the first polymeric substrate, wherein the exposed layer of abrasion-resistant, electrically conductive nano-scale graphite particles is an optically transparent layer and
has a surface resistance of less than 1×10⁵ Ohms/square, and wherein the exposed layer of abrasion-resistant, electrically conductive nano-scale graphite particles coated on the first major surface of the second polymeric substrate are coated by buff coating; and
stripes of adhesive on a portion of the electrically conductive coating on the first major surface of the first polymeric substrate such that portions of the electrically conductive coating remain exposed between the adhesive stripes.

11. The multi-layer cover tape construction of claim 10, further comprising a primer layer that forms a continuous layer between the electrically conductive coating and the adhesive stripes.

12. The cover tape of claim 10, wherein the exposed layer of abrasion-resistant, electrically conductive nano-scale graphite particles has a thickness of from 0.34 nanometers to 3 micrometers.

13. The cover tape of claim 10, wherein the adhesive comprises a pressure sensitive adhesive.

14. The cover tape of claim 10, wherein the exposed layer of abrasion-resistant, electrically conductive graphite nano-scale particles has a surface energy of between 25.0 and 30.0 milliNewtons/meter as measured by a water contact angle test.

15. The cover tape of claim 10, wherein the tape comprises a roll of tape with the exposed layer of abrasion-resistant, electrically conductive graphite nano-scale particles in contact with the low adhesion backsize coating layer.

16. The cover tape of claim 10, wherein the first polymeric substrate comprises a film of polyester, polyolefin, polyurethane, polyacrylate, polyvinyl, polymethylmethacrylate, polycarbonate, or combinations thereof.

17. A carrier tape assembly comprising:
a carrier tape for electronic component transportation, the carrier tape comprising:
parallel strip portions in a lengthwise direction, the strip portions having top and bottom surfaces, and between the parallel strip portions, a plurality of indented segments for accommodating electronic components formed intermittently in the lengthwise direction of the tape; and
a cover tape construction for releasably sealing the indented portions of the carrier tape, the cover tape construction comprising:
a first polymeric substrate with a first major surface and a second major surface;
a low adhesion backsize coating layer on the second major surface of the first polymeric substrate; and
an electrically conductive coating on the first major surface of the first polymeric substrate, the conductive layer comprising:
an exposed layer of abrasion-resistant, electrically conductive nano-scale graphite particles coated on the first major surface of the first polymeric substrate, wherein the exposed layer of abrasion-resistant, electrically conductive nano-scale graphite particles is an optically transparent layer and has a surface resistance of less than 1×10⁵ Ohms/square, and
wherein the exposed layer of abrasion-resistant, electrically conductive nano-scale graphite particles coated on the first major surface of the second polymeric substrate are coated by buff coating; and
stripes of adhesive on a portion of the electrically conductive coating on the first major surface of the first polymeric substrate such that portions of the electrically conductive coating remain exposed between the adhesive stripes,
and wherein the exposed adhesive stripes are releasably adhesively bonded to the top surface of the parallel strip portions of the carrier tape.

18. A method of forming a multi-layer cover tape construction comprising;
providing an adhesive tape construction comprising:
a first polymeric substrate with a first major surface and second major surface;
a low adhesion backsize coating on the second major surface of the first polymeric substrate; and
an adhesive layer coated on the first major surface of the first polymeric substrate;
forming an electrically conductive film construction comprising:
providing a second polymeric substrate with a first major surface and a second major surface;
applying a dry particle composition comprising graphite particles to the first major surface of the second polymeric substrate, wherein the dry particle composition comprising graphite particles comprises particles having a largest dimension of less than 100 micrometers, and comprising graphite using an applicator pad and buffing an effective amount of the graphite particles onto the surface of the polymeric substrate at a pressure normal to the surface of greater than 0 and less than about 30 grams per centimeter, wherein the applicator pad moves in plane parallel to the surface of the polymeric substrate in an orbital fashion; and
adhering the second major surface of the second polymeric substrate to the adhesive layer such that portions of the adhesive layer remain exposed on either side of the second polymeric substrate, wherein the buff coated graphite surface on the first major surface of the second polymeric substrate is optically transparent and has a surface resistance of less than 1×10⁵ Ohms/square.

19. A method of forming a multi-layer cover tape construction comprising;
providing a first polymeric substrate with a first major surface and second major surface with a low adhesion backsize coating on the second major surface of the first polymeric substrate; and
forming an electrically conductive coating on the first major surface of the first polymeric substrate, wherein forming an electrically conductive coating comprises:
applying a dry particle composition comprising graphite particles to the first major surface of the first polymeric substrate, wherein the dry particle composition comprising graphite particles comprises particles having a largest dimension of less than 100 micrometers, and comprising graphite using an applicator pad and buffing an effective amount of the graphite particles onto the surface of the polymeric substrate at a pressure normal to the surface of greater than 0 and less than about 30 grams per centimeter, wherein the applicator pad moves in plane parallel to the surface of the polymeric substrate in an orbital fashion; and
applying adhesive stripes to a portion of the electrically conductive coating on the first major surface of the first polymeric substrate such that portions of the electrically conductive coating remain exposed between the adhesive stripes; and wherein the buff coated electrically conductive graphite surface on the first major surface of the first polymeric substrate is optically transparent and has a surface resistance of less than 1×10⁵ Ohms/square.

20. The method of claim 19, wherein applying adhesive stripes to a portion of the electrically conductive coating on the first major surface of the first polymeric substrate, further comprises applying a primer layer stripes to the electrically conductive coating prior to applying the adhesive stripes, such that the primer layer stripes form continuous layer between the electrically conductive coating and the adhesive stripes.
